(19) United States
(12) Patent Application Publication
(10) Pub. No.: US 2003/0061080 A1
(43) Pub. Date: Mar. 27, 2003

(54) Check-in, queuing, visa, paging and assessment systems

(76) Inventor: Richard Thomas Ross, Silver Water (AU)

Correspondence Address: LADAS & PARRY, 26 WEST 61ST STREET, NEW YORK, NY, 10023, US

(21) Appl. No.: 10/218,949

(22) Filed: Aug. 14, 2002

Related U.S. Application Data
(63) Continuation-in-part of application No. 08/722,056, filed on Nov. 26, 1996, now abandoned.
Application No. 08/722,056 is a 371 of international application No. PCT/AU95/00210, filed on Apr. 12, 1995.

(30) Foreign Application Priority Data
Apr. 12, 1994 (AU) PM 4995
May 26, 1994 (AU) PM 5885
Sep. 30, 1994 (AU) PM 8546
Sep. 30, 1994 (AU) PM 8536

(51) Int. Cl. G06F 17/60

(52) U.S. Cl. 705/6

(57) ABSTRACT

A check-in guidance system for guiding passengers (4) who are checking in to a transport service in an environment having a passenger waiting area (18) and a plurality of check-in points (2) operated by check-in point operators (10), the check-in guidance system comprising: passenger information input means (12) at which passengers (4) who wish to check in to the transport service register their arrival, and input information relating to their travel requirements; display means (20) for displaying information to passengers waiting in said waiting area; a plurality of operator information input means (34), each located at a respective check-in point (2), at which check-in point operators (10) input information relating to the checking in of passengers (4); and computing means for sorting passengers (4) who have input information into said passenger information input means (12) into a priority sequence according to the order in which they should be checked in, and for controlling, in response to information received from the passenger information input means (12) and the operator information input means (34), the information displayed on the display means (20) so as to direct passengers (4) from the waiting area (18) to the check-in points (2) in accordance with said priority sequence.

### FIELD OF THE INVENTION

The first aspect of the invention relates to check-in guidance systems for guiding passengers who are checking in to a transport system, and particularly, although not exclusively, for guiding passengers who are checking in at an airport.

### BACKGROUND OF THE INVENTION

Passengers arriving at an airport are required check in themselves and their baggage before being allowed to board their plane. Normally, if a number of different airlines operate at the airport, each airline provides a number of check-in points, staffed by check-in point operators, at which passengers travelling on that airline can check in. Passengers present their flight tickets to the check-in point operators, and are in turn provided with boarding passes which allow them to board the flight. Passengers' baggage is also checked in at the check-in points and, after being weighed, is placed on a moving baggage belt which conveys it to a baggage handling section. If a passenger's baggage exceeds a specified limit and the passenger is required to pay excess baggage charges, the passenger is usually directed to a separate sales centre which has a number of service points, staffed by service point operators. The sales centre then issues the passenger with a boarding pass once any excess baggage payment has been made. The sales centre often provides a number of other services, in addition to the collection of excess baggage payments, such as reissuing tickets, ticket sales, flight bookings, and providing general information on flights and services provided by the airline.

A number of problems arise in the operation of such a system. For example, long queues can build up at the check-in points and at the service points of the sales centre. Such queues have a number of disadvantageous effects. Firstly, long queues obstruct the free movement of people around the airport, and lead to congestion. The queues can also have the effect of obscuring other check-in points from view and/or making other check-in points difficult to reach, with the result that certain check-in points become under-used, thus reducing the overall efficiency of the system.

Secondly, long queues also, of course, result in frustration and annoyance of passengers, which can cause passengers to be less likely to travel with the same airline again.

Thirdly, long queues mean that there is a substantial delay between a passenger arriving at the airport and checking in his baggage. Such a delay can prove disastrous if the passenger has arrived late and his flight is about to depart. If the passenger pushes to the front of the queue, or is allowed to jump to the front of the queue, other passengers may become resentful, particularly if they are not aware of the late passenger's situation.

A further disadvantage of such a system is that, in order to provide a faster service for first and business class passengers, it is necessary to provide one or more separate check-in points which are dedicated to the service of first and business class passengers. If queues form at the dedicated check-in points, then first and business class passengers are, in any case, obliged to wait.

Another disadvantage of such as system is that, if a passenger at the front of a queue has a problem which takes some time to sort out with the check-in point operator, there is no mechanism for transferring the other passengers in that queue to other check-in points in an orderly and fair manner.

If a late passenger is required to pay excess baggage charges, then even if he is able to proceed quickly through the check-in procedure, he may be delayed in queuing at the sales centre. Again, such a delay could prove disastrous if the departure of his flight is imminent.

A still further disadvantage of such a system is that, although an airline is aware of which passengers have already checked in to a particular flight, it is not aware of which, or how many, passengers have already arrived at the airport but are still waiting to check in.

The invention seeks to overcome at least some of the problems of the prior art.

### SUMMARY OF THE INVENTION

According to the first aspect of the invention there is provided a check-in guidance system for guiding passengers who are checking in to a transport service in an environment having a passenger waiting area and a plurality of check-in points operated by check-in point operators, the check-in guidance system comprising:

passenger information input means at which passengers who wish to check in to the transport service register their arrival, and input information relating to their travel requirements;

display means for displaying information to passengers waiting in said waiting area;

a plurality of operator information input means, each located at a respective so check-in point, at which check-in point operators input information relating to the checking in of passengers; and

computing means for sorting passengers who have input information into said passenger information input means into a priority sequence according to the order in which they should be checked in, and for controlling, in response to information received from the passenger information input means and the operator information input means, the information displayed on the display means so as to direct passengers from the waiting area to the check-in points in accordance with said priority sequence.

Such a check-in guidance system provides a number of benefits. There is no need for passengers to form long queues at each check-in point, and congestion and frustration are thereby avoided. In addition, first and business class passengers can be given priority over other passengers without the need for separate dedicated first and business class check-in points. When a first or business class passenger registers his arrival at the passenger information input means, the computing means can assign the first or business class passenger a higher position in said priority sequence than other passengers, and cause the display means to direct the first or business class passenger to the next available check-in point that becomes free. This process can take place transparently to the other passengers, who remain unaware that another passenger, arriving later than themselves, has been granted a higher priority, and has effectively jumped the queue.

Furthermore, a late passenger can automatically be given a higher priority than other passengers of the same class who are checking in for a later flight, without the other passengers being aware that the late passenger has effectively jumped in front of them.

Preferably, each operator information input means comprises a respective paging means which, on actuation by the corresponding check-in point operator, causes the next passenger in said priority sequence to be directed by the display means from the waiting area to the corresponding check-in point.

This feature allows the check-in point operator to control the length of the queue, if any, at his or her check-in point. The check-in point operator can keep the queue down to a reasonable number, for example two or three passengers, while at the same time ensuring that there is never a period when there are no passengers waiting to be checked in at the check-in point of the check-in point operator.

Advantageously, each operator information input means comprises commence-serve means which, when actuated by the check-in point operator, informs the computing means that the check-in point operator is beginning to serve the next passenger, so that the computing means knows who is being served at any given check-in point at any given time.

One advantage of such a commence-serve means is that it allows the computer to generate statistics on the operation of the check-in guidance system. For example, the computing means can calculate the average time that it takes any given check-in point to check in a passenger, or the average time between paging and service.

Preferably, each operator information input means comprises no-show means which, when actuated by the check-in point operator, informs the computing means that a passenger who has been directed to the check-in point by the display means has failed to show at the check-in point, so that the computing means can decide whether, and if so when, to allow the passenger to be repaged.

It will be appreciated that there are a number of possible ways in which this could be done. For example, such a no-show passenger could be simply returned to a lower position in the priority sequence, and repaged in the normal way when he or she again reached the top of the priority sequence. Alternatively, the no-show passenger could be allowed to be repaged after a fixed time interval following actuation of the no-show means.

Preferably, each operator information input means comprises on-duty means which, when actuated by the check-in point operator, informs the computing means that the check-in point is operational and can have passengers directed to it by the display means.

Similarly, the operator information input means also preferably comprises off-duty means which, when actuated by the check-in point operator, informs the computing means that the check-in point is no longer operational, and can no longer have passengers directed to it by the display means.

These features allow check-in point operations to leave check-in points, for example in order to take a tea break or to perform other duties.

In one embodiment of the invention, the operator information input means comprises return-to-queue means which, when actuated by the check-in point operator, informs the computing means that the passenger who is currently being served at that check-in point is to be returned to the waiting area to await repaging.

Such a return-to-queue means can be used when a passenger enters incorrect information at the passenger information input means. For example, if an economy class passenger specifies at the passenger information input means that he is a first class passenger, then the check-in point operator has the discretion to return the passenger to the waiting area, and to correct the erroneous information entered by the passenger, so that the passenger is then paged at the correct time. Of course, if the check-in point operator feels that the passenger's mistake is genuine then the check-in point operator has the discretion to check in the passenger and not actuate the return-to-queue means.

Preferably, the operator information input means comprises first transfer-request means which, when actuated by the check-in point operator, informs the computing means that all passengers at that check-in point other than the passenger currently being served are to be transferred to one or more other check-in points.

The first transfer-request means is particularly useful in the case where there is a problem with the checking in of a passenger, and the check-in point operator foresees that the problem will take some time to resolve. After actuation of the first transfer-request means, the other passengers can be redirected to other check-in points by means of the display means. Furthermore, if more than one passenger is to be transferred, the computing means can ensure that the priorities of the passengers are preserved in the transfer.

In a preferred embodiment of the invention, the operator information input means comprises second transfer-request means which, when actuated by the check-in point operator, informs the computing means that the passenger who is currently being served is to be transferred to another check-in point.

The second transfer-request means can allow the check-in point operator to specify where the passenger is to be transferred to.

For example, the check-in point operator may wish to transfer the passenger to a supervisor station if the check-in point operator is unable to deal with a particular problem.

In the cases of both the first and second transfer-request means, if there are insufficient free check-in points available, the computing means returns passengers to the waiting area to await redirection by the display means.

Preferably, the operator information input means comprises operator display means which displays information to the check-in point operator under the control of the computing means.

For example, the operator display means can display information identifying the check-in points to which passengers are to be transferred after actuation of the first or second transfer-request means.

In that case, the operator display means allows the check-in point operator to tell the passengers in the queue for that check-in point where they are being transferred to, so that the passengers do not have to rely entirely on the display means.

The first and second transfer-request means can also be used in the event of the failure of a luggage belt. If the luggage belt serving a particular group of check-in points suffers a breakdown, then the check-in point operators for those check-in points can request that all passengers waiting at their check-in points are transferred to other check-in points, and at the same time actuate their off-duty means to indicate that their check-in points are no longer operational.

Preferably, the operator display means displays information which informs the check-in point operator which passengers, if any, have been paged but not yet served. In such a case, the check-in point operator always knows how may passengers should be in the queue for the check-in point.

Preferably, each check-in point is provided with a respective display device which displays information to passengers at the check-in point under the control of the computing means, and the information displayed by the display device confirms to passengers arriving at the check-in point that they are at the correct check-in point.

Preferably, the passenger information input means allows passengers to specify their flight number, the class they are travelling, and/or the number of people in their group.

Conveniently, the passenger information input means comprises a machine reading device for machine reading information, such as that specified above, from media provided by passengers.

For example, in the case of an airport, air tickets can be provided with a magnetic strip or bar code adapted to be read by the machine reading device.

Additionally or alternatively, the passenger information input means can be provided with a touch sensitive screen for allowing passengers to input information.

In that case, the touch sensitive screen can display a plurality of areas, each area labelled with a respective letter of the alphabet, and the required information can be input by touching each area in turn, the letter corresponding to each area being displayed on the screen each time the corresponding area is touched so that the user can view the information being entered.

In one embodiment of the invention, the passenger information input means comprises a voucher dispenser for dispensing vouchers to passengers, each voucher bearing one or more identifying letters and/or numbers which can be displayed by the display means to guide passengers to the correct check-in points.

In the case of a group of passengers who are travelling together, the voucher dispenser dispenses a single voucher to the group, and the group is treated as a single entity as it passes through the system.

It should be appreciated that the check-in guidance system is designed to handle both single passengers and groups of passengers, and the word “passenger” above should be interpreted as referring to either a single passenger or a group of passengers. Thus, for example, if a check-in point operator, while checking in a group of passengers, actuates the second transfer-request means, the whole group of passengers is transferred to another check-in point.

The vouchers which are dispensed by the voucher dispenser can be provided with additional information designed to assist passengers through the check-in guidance system.

For example, the voucher can specify where the appropriate waiting area is located, and the time by which passengers should arrive at the waiting area. This allow passengers to make maximum use of their time. For example, passengers may wish to make purchases or eat and drink before checking in.

If required, the passenger information input means can be adapted to receive and validate money from passengers, and to dispense a voucher only if a required fee is paid.

Such a system could be used, for example, to collect departure tax at an airport.

If the transport service requires to collect excess baggage payments from passengers whose baggage weight exceeds specified limits, and if said environment is provided with separate service points at which excess baggage payments are collected, the check-in guidance system can comprise second display means for displaying information, under the control of the computing means, to direct each passenger who is waiting to make an excess baggage payment to a specified one of the service points, in an order determined by the computing means.

Such a system has the advantage of allowing certain passengers, for example first and business class passengers and late passengers to proceed through the service points at a faster rate.

If, as is commonly the case, the service points provide other services in addition to collecting excess baggage payments, for example providing sales information, then the check-in guidance system can further comprise a service point voucher dispenser for dispensing vouchers to people who wish to use a service point but do not require to make an excess baggage payment, each voucher bearing one or more identifying numbers and/or letters which can be displayed by the second display means to guide people to the service points.

The check-in guidance system can further comprise service information input means to allow people to specify the service they require, or the nature of their enquiry.

Where there are passengers who do not require to check-in physically or lodge baggage, ticket reading means can be provided at which passengers can present machine readable flight tickets.

The ticket reading means may read a magnetic stripe or other form of information encoded on the ticket, and verify its validity for a particular airline, date, flight and class.

Then the ticket reading means may automatically notify a reservation system that the particular passenger has arranged at the airport or city terminal or airport bus terminal (by the presentation of his/her ticket) and is about to be issued with a valid flight boarding pass.

Preferably, the ticket reading means then marks the ticket or removes the relevant ticket or portion of ticket from any attendant ticket sachet or other stapled or attached portions.

Thereupon, the ticket reading means can automatically issue a boarding pass which itself may be encoded to allow automatic entry through machine reading checkpoints to the passageways leading to the respective aircraft if such access is desired.

Conveniently, the ticket reading means incorporates means to enable the passenger selecting automatic issue of a boarding pass to make a choice as to seating position e.g. window or aisle—smoking or non-smoking.

Further, having obtained a boarding pass by this means, a passenger can conveniently approach the ticket reading means to change seating position. In such event, the passenger can re-insert the boarding pass. This would be automatically checked.

The passenger may notify (by means of a keyboard, touchscreen, etc) any change required. If the desired seating is available, the changes to the records of the seating reservation system would be made and a replacement boarding pass automatically issued.

The guidance system can further comprise a boarding pass which when interrogated by a signal at a checkpoint is triggered into responding with its encoded date. Such a transponding boarding pass can be of any suitable material, and can embody its own microprocessor. It can be self powered (e.g. electric cell or battery of cells; photovoltaic type energy acceptance from ambient light sources) or powered by any form of stored energy. For example, the boarding pass may convert some or all of the energy received from the interrogating signal and gain sufficient energy by this means to transmit its code response.

The invention also independently provides a touch sensitive screen for allowing a user to input information into a computing means, the touch sensitive screen being divided into a number of regions, and each region displaying a respective letter of the alphabet so that actuation of any one of said regions by the user causes the letter associated with that region to be displayed at another location on the touch sensitive screen.

It will be appreciated that such an arrangement allows a touch sensitive screen to double as a keyboard and screen, thus removing the need for the user to use a separate mechanical-type keyboard to input information. Such an arrangement can also serve as a multilingual keyboard, in which case after the user has specified the language required, the number of regions on the touch sensitive screen can change if the required alphabet has a different number of letters. Of course, additional regions of the touch sensitive screen can be allocated for punctuation, numbers and other functions.

A second aspect of the invention relates to a queue management system.

The traditional method of queuing involves clients standing in a line one behind the other. It is well known that queuing in this manner can be a frustrating and tiring experience, especially if the queue is long and slow moving. In addition, such a method of queuing can also be inefficient, particularly in the case where it is necessary for clients to form several different queues for different services. If a client finds himself inadvertently in the wrong queue he may find that, having worked his way to the front of that queue, he is then forced to join the back of a different queue. This simply frustrates the client further, and wastes time.

Furthermore, once the client reaches the front of the queue it is sometimes necessary for him to identify himself to a member of staff, and for the member of staff to search for information that relates specifically to that particular client. This process takes time, which can lead to longer queues or to the need to employ additional members of staff.

In addition, if statistical information is required on the use of the service, such information can be time consuming and costly to prepare, particularly if it involves sorting through manual records.

The invention seeks to overcome or ameliorate such problems, and to provide a number of other benefits, as will be described below.

According to the second aspect of the invention there is provided a queue management system comprising:

a service device for providing people with information, the service device comprising at least a screen for displaying information to users of the service device;

an authorisation device for determining whether people who wish to use the service device are authorised to use the service device;

a waiting area in which people wait after identifying themselves at the first identification device;

display means for displaying information to people waiting in the waiting area; and

computing means for controlling, in response to information received from at least the authorisation device and the service device, the information displayed on the display means so as to direct only those people who are authorised to use the service device sequentially from the waiting area to the service device, in an order determined by the computing means, so that the service device is used by people from the waiting area one after the other.

Such a system avoids the need for people to stand in a queue, and allows them to wait in a more relaxed manner in a waiting area, which can for example be provided with chairs.

The system also provides the advantage of allowing the computing means to automatically keep track of how the system is being used, and to automatically provide statistical information on the use of the system.

The authorisation device can comprise a first identification device for identifying people who wish to use the service device in order to determine whether they are authorised to use the service device.

Additionally or alternatively, the authorisation device can comprise a payment device for accepting a payment from people wishing to use the service device, and said determination of whether said people are authorised to use the service device can depend on whether or not a required payment is made.

Preferably, the queue management system further comprises a second identification device at the location of the service device (regardless of whether or not the system also comprises said first identification device) for identifying people who wish to use the service device, and allowing use of the service device by only those people who have been directed to the service device by the display means.

In one embodiment of the invention, the service device is connected to, and controlled by, the computing means.

The computing means can collect statistical data not only on such things as the number and rate of people using the system, but also on what information is being supplied to people using the service device.

It will also be appreciated that a number of benefits flow from the fact that the identity of each user of the system is identified by the first and second identification devices. For example, the service device is able to provide information which is specific to each user of the system. In addition, the computing means is able to collect statistical information on each individual user, rather than simply on the use of the system as a whole.

The system can also include a staffed service point operated by a member of staff, and the display means can display information to direct people from the waiting area to the service point, in accordance with instructions sent to the display means by the computing means.

In this case, people can be directed to the service point before, after, or instead of, being directed to the service device.

Furthermore, the computing means can decide, on the basis of the identity of each person as determined by the first identification device, where each person should be directed by the display means.

There can be more than one service device, and more than one service point.

If there is more than one service device, each service device can be provided with a respective second identification device.

In addition, the service devices and service points need not be identical, and different service devices and service points can be adapted to provide different services to users of the system.

In this case, the computer means can decide, on the basis of the identity of each person as determined by the first identification device, to which service device or service point each person should be directed by the display means.

Additionally or alternatively, the authorisation device can be provided with input means for allowing the user to specify which of a range of services is required, and the computing means can decide where to direct the person on the basis of the choice that person has made at the input means.

The system can further comprise a ticket dispenser for dispensing tickets to people who are determined by the authorisation device to be authorised people, the tickets bearing one or more identifying numbers or letters, and the display means can be adapted to display said identifying numbers or letters in order to direct such authorised people to a service device or service point.

The first and second identification devices can be provided with machine reading devices for machine reading personal identification cards presented to the first and second identification devices by users.

For example, the personal identification cards can be provided with bar codes or magnetic strips.

In one embodiment of the invention, the ticket dispenser dispenses tickets which are provided with bar codes, and the second identification devices are provided with bar code reading devices for reading the bar codes on the tickets when the tickets are presented to the second identification devices, in order to allow use of the service devices by only those people who have been directed to the service devices by the display means.

The service devices can be provided with one or more printing devices for providing users with hard copies of information.

A third aspect of the invention relates to an automatic visa issuing device.

According to the third aspect of the invention there is provided an automatic visa issuing device, comprising applicant information input means at which an applicant for a visa inputs information relating to the applicant's request for the visa; computing means for storing and processing the information input by the applicant; and visa issuing means for issuing the visa to the applicant if the computing means determines that the applicant is entitled to the visa.

The visa issuing means can be an automatic stamping device for stamping the applicant's passport with a stamp representing the visa.

The visa issuing means can also comprise a sticker dispensing device for dispensing a visa sticker to the applicant, which can be stuck in the applicant's passport.

The applicant information input means can comprise a display screen for displaying general information to the applicant, prompting the applicant for required information, and/or displaying information input by the applicant.

Ideally, the issuing device further comprises a camera, and the display screen is adapted to display an image of the applicant produced by the camera.

In that case, the screen can be a touch sensitive screen, preferably of the type (displaying the alphabet) described above.

Preferably, the automatic visa issuing device further comprises payment means for accepting a payment from the applicant before issuing a visa, the issuance of the visa being dependent on the payment made.

For example, the payment means can comprise a coin and note validation device, and/or a bank card reader for debiting the applicant's bank account directly.

Ideally, the automatic visa issuing device comprises a passport reading device for reading, for example optically or magnetically, information from the applicant's passport before issuing a visa, the issuance of the visa being dependent on the information read.

Additionally or alternatively, the automatic visa issuing device can comprise image recording means for recording an image of the applicant, and providing the computing means with a digitised image of the applicant, so that the computer means can compare the digitised image with a digitised image of the owner of the passport presented to the passport reading device, and determine whether the applicant is the true owner of the passport.

The digitised image of the owner of the passport can be read by the passport reading device from a photograph in the passport, or can be stored in memory and accessed by the computing means on the basis of other information read from the passport.

A fourth aspect of the invention relates to a queue management system.

The traditional method of queuing involves clients standing in a line one behind the other. It is well known that queuing in this manner can be a frustrating and tiring experience, especially if the queue is long and slow moving. In addition, such a method of queuing can also be inefficient, particularly in the case where it is necessary for clients to form several different queues for different services. If a client finds himself inadvertently in the wrong queue he may find that, having worked his way to the front of that queue, he is then forced to join the back of a different queue. This simply frustrates the client further, and wastes time.

Furthermore, once the client reaches the front of the queue it is sometimes necessary for him to identify himself to a member of staff, and for the member of staff to search for information that relates specifically to that particular client. This process takes time, which can lead to longer queues or to the need to employ additional members of staff.

In addition, if statistical information is required on the use of the service, such information can be time consuming and costly to prepare, particularly if it involves sorting through manual records. If any kind of automated queuing system is employed, a further problem can arise if the system is to be used by clients who speak different languages, some of whom may find it difficult to follow the instructions for use of the system.

The invention seeks to overcome or ameliorate such problems, and to provide a number of other benefits, as will be described below.

According to the fourth aspect of the invention there is provided a queue management system comprising:

a service point for providing people with information;

an arrival device which people who wish to use the service point are required to operate on arrival at the system;

a multilingual instruction display device, comprising at least a screen and being located at or near the arrival device, for displaying information on how to use the system in a plurality of languages;

display means for displaying information to people waiting in the waiting area; and

computing means for controlling, in response to information received from at least the arrival device and the service point, the information displayed on the display means so as to direct people who have operated the arrival device sequentially to the service point, in an order determined by the computing means, so that the service point is used by people one after the other.

Conveniently, the system further comprises a waiting area in which people wait after operating the arrival device, and the display means directs people sequentially from the waiting area to the service point.

Such a system avoids the need for people to stand in a queue, and allows them to wait in a more relaxed manner in a waiting area, which can for example be provided with chairs.

The system also provides the advantage of allowing the computing means to automatically keep track of how the system is being used, and to automatically provide statistical information on the use of the system.

The arrival device can comprise an authorisation device for determining whether people who wish to use the service point are authorised to use the service point.

Preferably, the multilingual instruction display device comprises a touch sensitive screen, or a screen with buttons arranged alongside it, to enable users to make choices or enter information in response to information displayed by the screen.

For example, the multilingual instruction display device can allow the user to select in which language information is displayed by the multilingual instruction display device.

The authorisation device can comprise a first identification device for identifying people who wish to use the service point in order to determine whether they are authorised to use the service device.

Additionally or alternatively, the authorisation device can comprise a payment device for accepting a payment from people wishing to use the service point, and said determination of whether said people are authorised to use the service point can depend on whether or not a required payment is made.

Preferably, the queue management system further comprises a second identification device at the location of the service point (regardless of whether or not the system also comprises said first identification device) for identifying people who wish to use the service point, and allowing use of the service point by only those people who have been directed to the service point by the display means.

The service point can be a staffed service point operated by a member of staff. Alternatively, the service point can be a service device comprising at least a screen for displaying information to users of the service device.

In that case, the service device can be connected to, and controlled by, the computing means.

The computing means can collect statistical data not only on such things as the number and rate of people using the system, but also on what information is being supplied to people using the service point.

It will also be appreciated that a number of benefits flow from the fact that the identity of each user of the system is identified by the first and second identification devices. For example, the service point is able to provide information which is specific to each user of the system. In addition, the computing means is able to collect statistical information on each individual user, rather than simply on the use of the system as a whole.

The system can comprise both a staffed service point and a service device.

In that case, people can be directed to the staffed service point before, after, or instead of, being directed to the service device.

Furthermore, the computing means can decide, on the basis of the identity of each person as determined by the first identification device, where each person should be directed by the display means.

There can be more than one service device, and more than one staffed service point.

If there is more than one service point, each service point can be provided with a respective second identification device.

In addition, the various service devices and staffed service points need not be identical, and different service devices and staffed service points can be adapted to provide different services to users of the system.

In this case, the computer means can decide, on the basis of the identity of each person as determined by the first identification device, to which service device or staffed service point each person should be directed by the display means.

Additionally or alternatively, the authorisation device can be provided with input means for allowing the user to specify which of a range of services is required, and the computing means can decide where to direct the person on the basis of the choice that person has made at the input means.

Such an input means can be provided by the multilingual instruction display device.

The arrival device can be provided with a ticket dispenser for dispensing tickets to people operating the arrival device, the tickets bearing one or more identifying numbers or letters, and the display means can be adapted to display said identifying numbers and/or letters in order to direct people to a service device or staffed service point.

In that case, the ticket dispenser can be adapted to dispense tickets to people who are determined by the authorisation device to be authorised people.

The first and second identification devices can be provided with machine reading devices for machine reading personal identification cards presented to the first and second identification devices by users.

For example, the personal identification cards can be provided with bar codes or magnetic strips.

In one embodiment of the invention, the ticket dispenser dispenses tickets which are provided with bar codes, and the second identification devices are provided with bar code reading devices for reading the bar codes on the tickets when the tickets are presented to the second identification devices, in order to allow use of the service points by only those people who have been directed to the service points by the display means.

The service points can be provided with one or more printing devices for providing users with hard copies of information.

A fifth aspect of the invention relates to paging devices for use in queue management systems.

The check-in guidance system and various other queue management systems described above make use of paging devices for enabling staff members to page the next client, or more generally user, of the system. In the check-in guidance system described above, the operator module 34 can be regarded as the paging device. In the other queue management systems described above, the paging devices are not specifically illustrated in the accompanying figures, but reference is made to buttons (not shown) which are provided at the staffed service points 6, and which can be regarded as paging devices. It should be noted, however, that this aspect of the invention is not limited to paging devices for use in the particular queue management systems described above.

A problem which arises generally in the installation of paging devices for queue management systems is that each paging device must be electrically connected by a cable to the computer or computers which is or are controlling the queue management system. Typically, such a computer controls a display device which directs clients to the appropriate staffed service points in response to operation of the paging devices at the staffed service points by the members of staff who are operating the service points. Generally, each staffed service point is given a number, indicated by a position marker which is displayed by the display device in order to direct users to that staffed service point.

It will be appreciated that the installation of cabling connecting the paging devices can involve a substantial amount of labour, particularly if there are a large number of cables which must be routed across floors in an aesthetically pleasing manner, which is also safe and does not present a hazard to users of the system.

According to the fifth aspect of the invention there is provided a paging device for use in a queue management system having a number of service points for providing people with a service, each service point being operated by a staff member, the paging device comprising:

a paging unit, the operation of which by a staff member causes the next user of the system to be paged to that staff member;

at least one cable connecting the paging unit to a computer controlling the queue management system; and

guide means for guiding at least a portion of said cable from a ceiling above the paging unit to the paging unit, the guide means being provided with ceiling attachment means for attaching an upper portion thereof to said ceiling.

It will be appreciated that such a paging device allows cables from the paging device to be routed through the sealing of the building in which the queue management system is in operation, thus providing a substantial reduction in the labour involved in installing such cables.

Preferably, the paging unit comprises a display for displaying information to the staff member operating the paging unit. For example, the display can display the ticket number of the next client in the case where the queue management system involves dispensing numbered tickets to clients arriving at the queue management system.

Conveniently, at least a part of the paging unit, such as the display, is supported at the lower end of the guide means. This feature provides the advantage of removing the paging unit, or at least a part thereof, from the desk of the staff member, thus increasing the useable area of the desk.

Advantageously, the paging unit, or part thereof, supported at the lower end of the guide means is rotatably mounted to the guide means to allow its orientation to be adjusted to suite the staff member operating the paging unit.

Additionally or alternatively, the guide means can be of adjustable length to allow the paging unit, or part thereof, at the lower end of the guide means to be adjusted in height.

The paging device can further comprise a number identifier supported by the guide means for identifying the number of the staffed service point at which the paging device is located.

The sixth aspect of the invention relates to automated assessment.

According to the sixth aspect of the invention there is provided a method of assessing the ability of a person in a particular field, comprising displaying a plurality of questions on a screen controlled by computing means, recording the responses of the person to said questions, and using the computing means to carry out an analysis of said responses.

If the questions are displayed serially, that is one after the other, the method preferably further includes measuring the time taken by the person to answer each question.

It will be appreciated that the time taken on each question is valuable additional information, which can be included in said analysis.

The method can further include the step of automatically moving on to the next question if the person has not responded to a question within a predetermined time interval.

In this case, different predetermined time intervals can be used for different questions. For example, the time allowed for each question can be made to depend on the likely difficulty of the question to the person.

If the questions are displayed more than one at a time, the computing means can include, as a factor in said analysis, the order in which the person chooses to answer the questions.

In one embodiment of the invention, the method includes the step of stopping the test if an answer is given to a question which is inconsistent with an answer already given to a previous question.

The invention also provides an assessment device adapted to carry out the above method, comprising computing means, a screen for displaying the questions, and input means for enabling the person to input responses to the questions.

Conveniently, the screen and input means are combined in the form of a touch sensitive screen, or a screen with adjacent keys or a keyboard.

The invention also provides a client management system comprising one or more service points for providing clients with a service, and the assessment device described above, which people wishing to use the service point(s) are required to operate before proceeding to the service point(s), wherein the client management system further comprises communication means for communicating at least some of the results of said analysis to the service point(s).

The invention further provides a client management system comprising a plurality of service points for providing clients with a service, and the assessment device described above, which people wishing to use a service point are required to operate before proceeding to the service point, wherein clients, after having operated the assessment device are required to proceed to one of the service points, in dependence on the results of said analysis.

The service points mentioned above can be either staffed service points, automated service devices, or a combination of both.

In either of the client management systems described above, the questions presented to the client by the assessment device are preferably related to the service which is being provided by the service point(s) so that the client is not necessarily aware of the fact that he is being assessed by the assessment device.

If the assessment device is adapted to stop testing in the event of an answer being given by a client which is inconsistent with an answer already given to a previous question, in the manner described above, the client is preferably directed to a service point as soon as the test is stopped.

It will be appreciated that this reduces the time which the person has to spend at the assessment device.

The invention also provides a client management system comprising an automated service device for providing clients with a service, the service device being adapted to also operate as an assessment device of the type described above, and a queuing system for directing people wishing to use the service device to the service device one after the other.

The service device can, for example, be adapted to carry out literacy and/or psychometric testing using the method described above.

### BRIEF DESCRIPTION OF THE DRAWINGS

Embodiments of the various aspects of the invention are described below, by way of example only, with reference to the accompanying drawings, in which:

FIGS. 1 to 11 relate to the first aspect of the invention;

FIG. 12 relates to the second aspect of the invention;

FIG. 13 relates to the third aspect of the invention;

FIG. 14 relates to the fourth aspect of the invention;

FIG. 15 relates to the fifth aspect of the invention; and

FIGS. 16 to 19 relate to the sixth aspect of the invention.

### PREFERRED EMBODIMENTS OF THE INVENTION

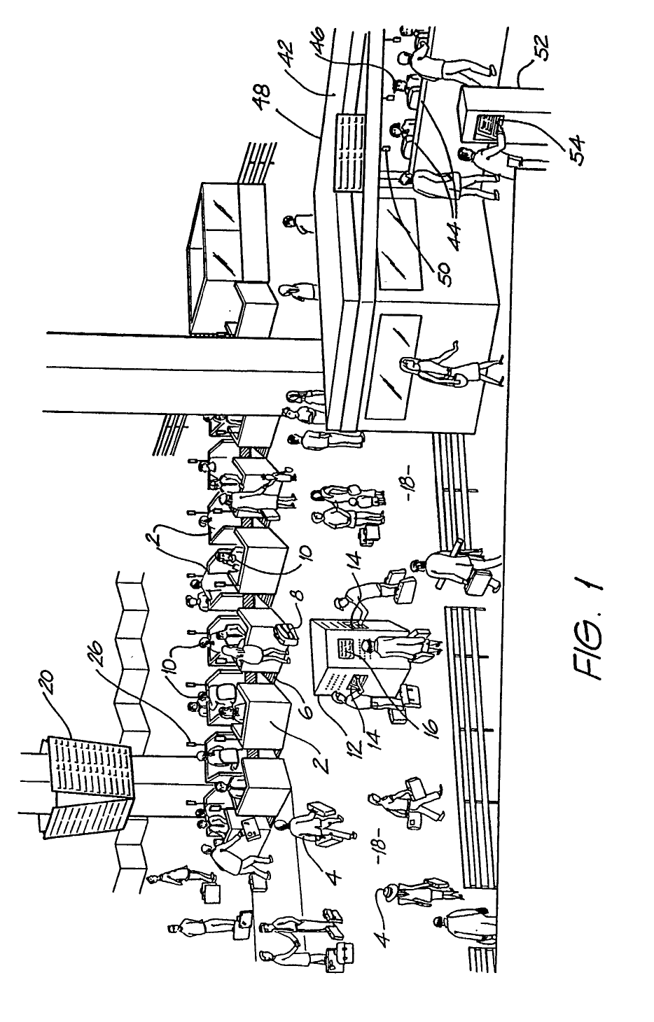

An embodiment of the first aspect of the invention will now be described, by way of example only, with reference to FIGS. 1 to 11 of the accompanying drawings, in which:

FIG. 1 shows a check-in guidance system in operation at an airport;

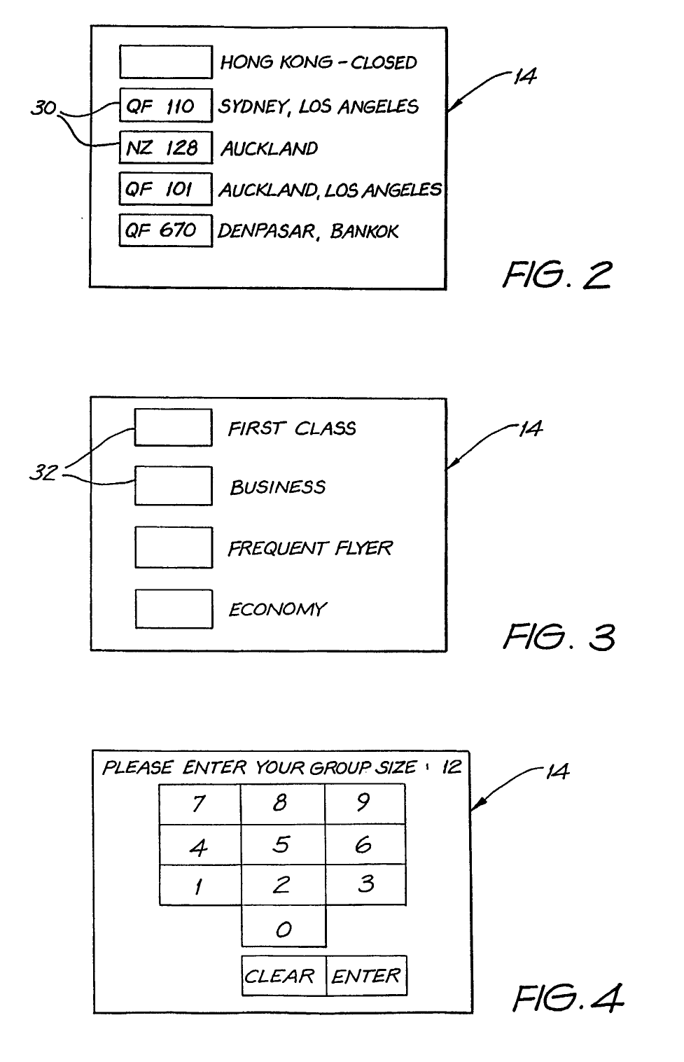

FIGS. 2 to 4 show three different layouts of a touch sensitive screen;

FIG. 5 shows part of a computer controlled display board;

FIG. 6 shows a check-in point operator serving a passenger at a check-in point; and

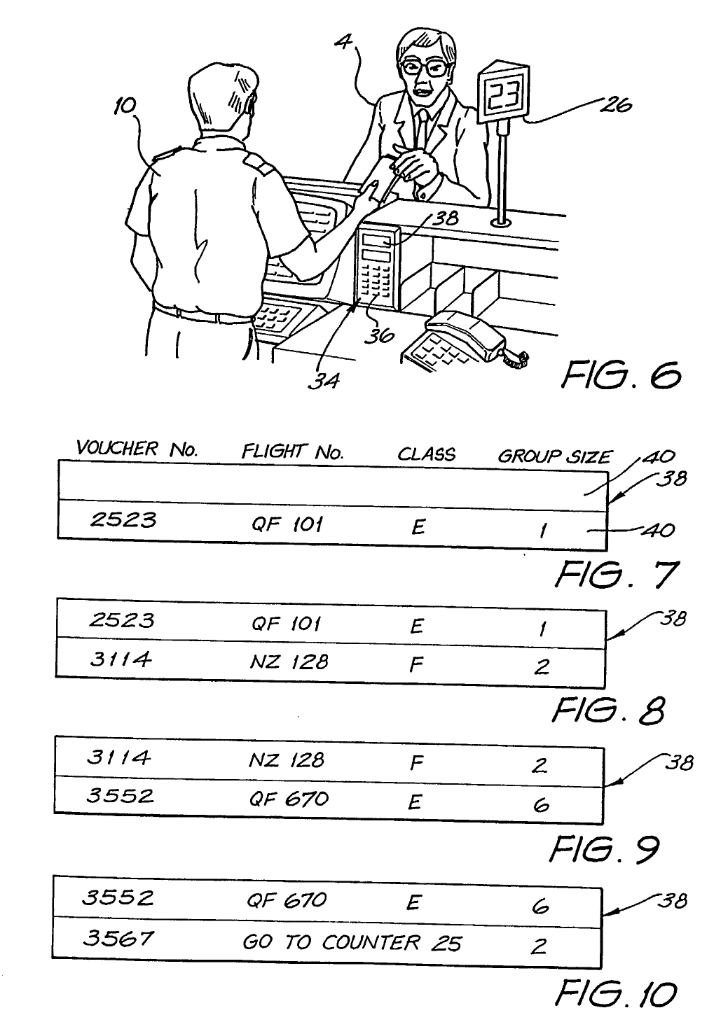

FIGS. 7 to 10 show various information displayed on the display of an operator module.

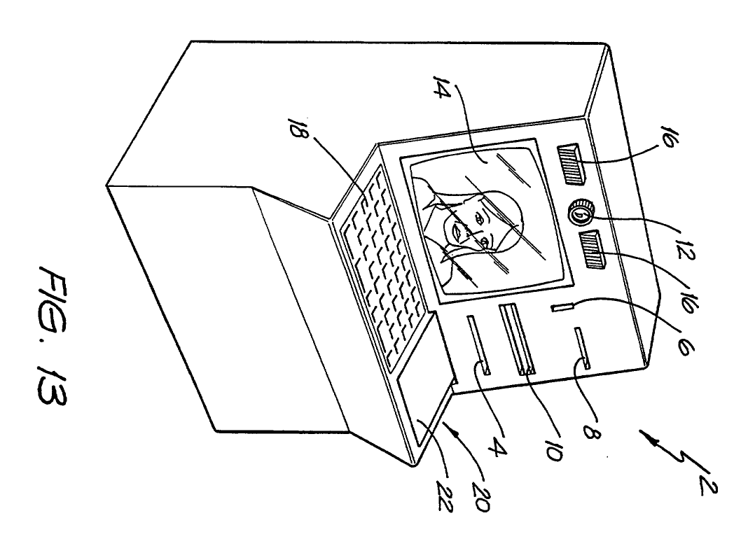

FIG. 11 shows a touch sensitive screen functioning as an alphanumeric keyboard.

FIG. 1 shows a number of check-in points 2 for checking in passengers 4 at an airport. The check-in points 2 are arranged around a luggage conveyor belt 6 which conveys passengers' luggage 8 from the check-in points 2 to a baggage handling area (not shown). Each check-in point 2 is staffed by a check-in point operator 10 who examines passengers' tickets and issues passengers with boarding passes.

When passengers arrive at the airport they are directed by appropriate signs (not shown) to a passenger information input kiosk 12, which is provided with a number of touch sensitive screens 14, at which passengers input information identifying their flight number, class and group size in a manner which will be described below.

The kiosk 12 then automatically dispenses a voucher to the passenger, which is printed with a four digit voucher number (other numbers or digits can of course be used). In the case of a group of passengers who are travelling together, a single voucher is dispensed, printed with a single voucher number, so that the group of passengers passes through the check-in guidance system as a single entity. The voucher is also printed with other useful information, including the part of the airport to which the passenger should proceed in order to check in, and the earliest and latest times by which the passenger should arrive to check in.

The passenger information input kiosk 12 is also provided with an information screen 16, which simply displays useful information to passengers and is not used for information input. The information screen 16 can display instructions for using the passenger information input kiosk 12, current information on flight delays and check-in times, and other useful information.

Once the passenger has received a voucher from the kiosk 12, the passenger is directed from a waiting area 18 to one of the check-in points 2 by a display board 20 which is controlled by a central computer (not shown), and which is mounted at an elevated location so that it is visible to all passengers waiting in the waiting area 18. Although only one waiting area 18 and one kiosk 12 are shown in FIG. 1, in other embodiments a number of waiting areas 18 can be present, each provided with one or more kiosks 12. In such a case, each waiting area is provided with at least one display band 20.

A portion of the display board 20 is shown in FIG. 5. The first line 22 specifies the flight number. The information on the display board 20 is divided up according to flight number, so that passengers for a particular flight only have to look at a particular portion of the display board 20. The first line 22 can be offset from the following information, so that it stands out to passengers viewing the display board 20. In addition, a number of different colours can be used for different information on the display board 20 in order to make the information easier to read.

The lines 24 of information immediately below the first line 22 each specify a four digit voucher number followed be a two digit check-in point number. This information directs a passenger or group of passengers having a particular voucher number to the check-in point 2 having the number which is displayed alongside the corresponding voucher number. The number identifying each check-in point 2 is displayed on a check-in point number identifier 26 located at each check-in point 2.

The remaining lines of information 28 each contain a voucher number followed by the word “NEXT”. The purpose of these lines of information is to alert those passengers who are shortly to be directed to one of the check-in points 2.

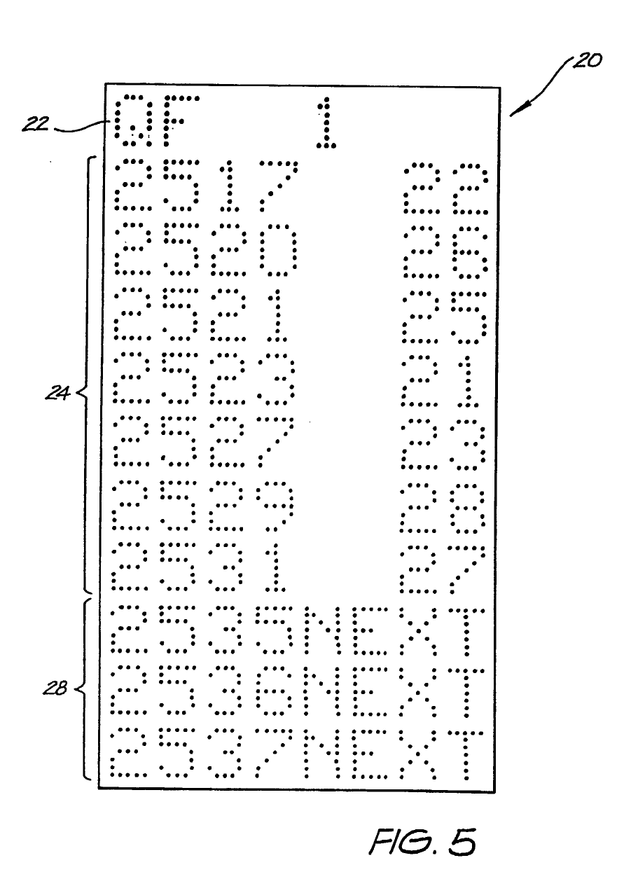

The touch sensitive screens 14 of the kiosk 12 display various pages of information to passengers in order to obtain the required information. The first page is shown in FIG. 2. The passenger is required to touch one of boxes 30 in order to specify his flight number. The page shown in FIG. 3 is then displayed to the passenger, and the passenger is required to touch one of the boxes 32 in order to specify the class which he is travelling. Once he has done this, the page shown in FIG. 4 is displayed, and the passenger is required to input the size of his group. If the passenger is travelling alone, he simply enters one.

In an alternative non-illustrated embodiment of the invention the passenger is required to input additional information, for example information identifying himself. In a further alternative embodiment, the passenger information input kiosk 12 is provided with devices for reading bar codes or magnetic strips, thus allowing the information to be input quickly and easily without the need for the passenger to use a touch sensitive screen.

If additional information is required, the touch sensitive screen 14 can display an alphanumeric keyboard on part of the screen, as shown in FIG. 11, and the passenger can type in the required information by touching the key areas 31 on the screen 14. Prompts 33 and information typed by the passenger appear on the upper part of the screen 14.

All information which is collected at the kiosk 12 is fed to the central computer which sorts the passengers into a priority sequence, and determines which passengers should be allowed to check in next.

Any information displayed at the kiosk 12 can be displayed in a number of alternative languages, as specified by the passengers using the kiosk 12.

The kiosk 12 is also provided with a coin and note validation (not shown) for collecting a departure tax from passengers. The departure tax must be paid before a voucher is issued.

In an alternative embodiment of the invention the display board 20 displays the surname (or a portion of the surname) and/or the ticket number of each passenger, rather than a voucher number for each passenger. It will be appreciated that, in such an embodiment, the kiosk 12 need not dispense vouchers.

FIG. 6 shows one of the check-in points 2 in operation. Each check-in point 2 is provided with an operator module 34, which is connected to the central computer. Each operator module 34 is provided with a number of buttons 36, and a display 38. The operation of the operator module 34 will now be described.

The operator module 34 is provided with buttons which are labelled ON-DUTY, OFF-DUTY, PAGE, COMMENCE-SERVE, NO-SHOW, RETURN-TO-QUEUE, TRANSFER-FIRST, and TRANSFER-OTHERS (not specifically shown in FIG. 6). Although the embodiment being described uses a number of separate buttons 36, it will be appreciated that there are any number of other arrangements which would perform the same function. For example, the buttons 36 could be replaced by a computer keyboard and/or mouse, and the display 38 could be replaced by a conventional computer VDU, or a touch sensitive VDU. Such an arrangement is particularly suitable if the system is implemented using a Local Area Network.

The ON-DUTY button is used by the check-in point operator 10 to indicate to the central computer that he is on duty, and that passengers may be directed to the check-in point 2 by the display board 20 under the control of the central computer. Similarly, the check-in point operator 10 presses the OFF-DUTY button when he is going off duty. The central computer then knows that no further passengers should be directed to that check-in point 2.

When the check-in point operator 10 wants the display board 20 to direct another passenger to his check-in point 2 he actuates the PAGE button. It will be appreciated that the check-in point operator 10 can use the PAGE button to control the length of the queue at his check-in point 2, and to ensure that there are always at least some passengers waiting to be served at his check-in point 2. At the same time, the check-in point operator 10 is able to keep the size of his queue down to a minimum so as to avoid congestion, and also to avoid frustration of passengers.

The COMMENCE-SERVE button is used by the check-in point operator 10 each time he begins to serve a new passenger or group of passengers. The purpose of the COMMENCE-SERVE button is to keep the central computer informed of who is being served at any given check-in point 2 at any given time, and to allow the central computer to generate statistics as has been described above.

If a passenger has been paged but fails to show up at the check-in point 2, the operator 10 presses the NO-SHOW button in order to indicate this fact to the central computer. The central computer can then decide when the passenger should be allowed to be repaged, as has been described above.

The RETURN-TO-QUEUE button allows the operator 10 to return the passenger who is currently being served to the waiting area 18 to await repaging. This might be necessary if the passenger has entered the wrong information at the kiosk 12. For example, the passenger may have indicated that he is travelling first class, when in fact he is travelling economy.

Under certain circumstances the operator 10 may wish to transfer the passenger who is being served to another check-in point 2 which is being operated by a supervisor or a more senior check-in point operator 10. This would be the case if there is a problem in the checking in of the passenger which requires to be dealt with by a more senior person. In such a case the operator 10 can press the TRANSFER-FIRST button, which informs the central computer that the first person in the queue, namely the person who is currently being served by the operator 10, is to be transferred to another check-in point 2. The operator module 34 can include provision for allowing the operator 10 to specify where the passenger is to be transferred to.

Under other circumstances the operator 10 may wish to transfer all of the passengers in the queue, except who is currently being served, to one or more other check-in points 2. This is done by pressing the TRANSFER-OTHERS button. An example of an instance where the TRANSFER-OTHERS button is used is when there is a problem with the checking of a passenger and the operator 10 foresees that the problem may take some time to resolve.

As has been explained above, in the event of a crisis situation, such as the failure of the luggage conveyor belt 6, the operator can press both the TRANSFER-FIRST and the TRANSFER-OTHERS buttons in order to transfer all of the passengers in his queue to one or more other check-in points 2. In such a case, the operator 10 would also press the OFF-DUTY button so as to ensure that no further passengers are directed to his check-in point 2 until the crisis situation has been resolved.

FIGS. 7 to 10 are schematic drawings showing some examples of information displayed on the display 38 of the operator module 34. FIG. 7 shows the case where an operator 10 has just come on duty and has pressed the PAGE button. It will be seen that information relating to the passenger who has been paged is displayed on the lower of two lines 40 on the display 38. In the example, the central computer has decided to page a single passenger having voucher number 2523, who is travelling economy on flight number QF101.

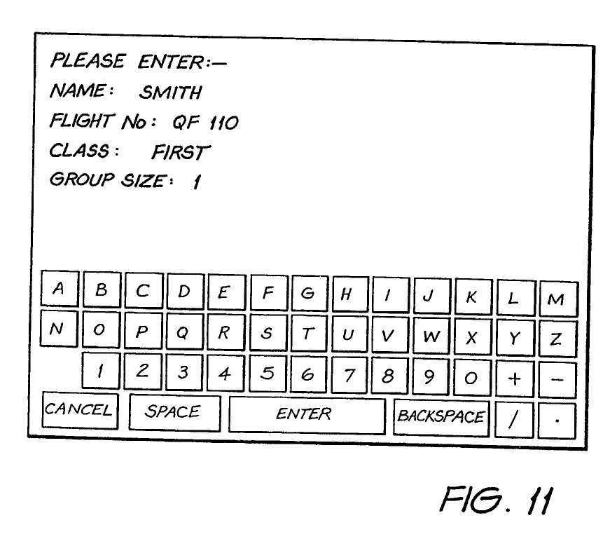

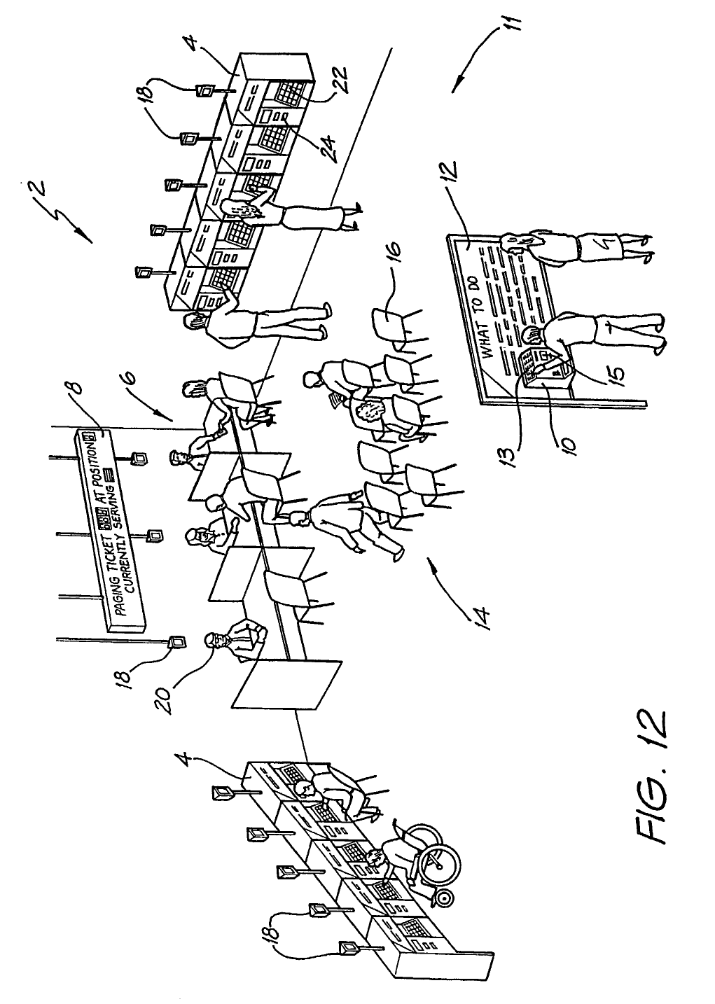

When the passenger having voucher number 2521 arrives at the check-in point 2, the operator 10 presses the COMMENCE-SERVE button and again presses the PAGE button. The display 38 then displays the information shown in FIG. 8 in which the information relating to the first passenger moves up to the upper line of the display 38, and information relating to the passenger who has been paged appears on the lower line. When the operator 10 has finished serving the passenger with voucher number 2523, he again presses the PAGE and COMMENCE-SERVE buttons, and the information on the display 38 changes to that shown in FIG. 9. In the example, the check-in operator 10 then experiences a problem with the checking in of the passenger having voucher number 3552, and decides that the problem is likely to take some time to resolve. The operator 10 therefore presses the TRANSFER-OTHERS button and the computer transfers the next group of two passengers (having voucher number 3567) to check-in point number 25. In such a case the display board 20 indicates that the two passengers having voucher number 3567 should proceed to check-in point number 25. However, the check-in point number to which the passengers are being transferred is also displayed on the display 38 of the operator module 34, as shown in FIG. 10, so that the two passengers who are being transferred can be told by the check-in point operator 10 where they are being transferred to, and do not have to rely entirely on the display board 20.

Although FIGS. 7 to 10 show a display 38 having only two lines 40, the display 38 can have any number of lines. Ideally, the display 38 has sufficient lines to display the details of all passengers who have been paged to that check-in point 2.

The check-in point number identifier 26 also comprises a computer controlled display which is controlled by the central computer to display the voucher numbers of all passengers who have been paged to the corresponding check-in point 2 but not yet served. The display is not shown in FIG. 6 because it is located on the reverse side of the number identifier 26. The display performs the function of verifying to passengers who are arriving at the check-in point 2 that they have come to the correct check-in point 2.

It will be appreciated that at all times the central computer controls the order in which passengers are checked in. The greatest priority is given to first class passengers, followed by business, frequent flyer and economy passengers in that order. The system avoids the need for dedicated first and business class check-in points 2, since any of the check-in points 2 can be used to check in any class of passenger. Furthermore, the central computer can allow late passengers to pass quickly through the check-in procedure in order to avoid missing their flights.

FIG. 1 also shows a sales centre 42 provided with a number of service points 44, each staffed by a service point operator 46. If a passenger is required to make an excess baggage payment, he is directed from the check-in point 2 to the sales centre 42 by the check-in point operator 10. The passenger is then served by one of the service point operators 46, who gives the passenger a boarding pass on payment of the excess baggage charge. The sales centre is provided with a second display board 48 which is controlled by the central computer, and operates in the same way as the display board 20 to direct each passenger to a particular service point 44, the service points 44 being identified by number identifiers 50. Again, the central computer gives priority to the passengers waiting at the sales centre 42 in accordance with their class, and also gives a higher priority to late passengers.

Other people, besides passengers requiring to make excess baggage payments, can use additional services provided by the sales centre 42 by obtaining a service voucher from a voucher dispenser 52 located in the sales centre 42. Each service voucher is printed with a voucher number which allows the person holding the service voucher to be directed to one of the service points 44 by the second display board 48. The voucher dispenser 52 also comprises a touch sensitive screen 54 at which people can specify the particular service which they require from the sales centre 42. In the past, instances have arisen where a passenger requiring to make an excess baggage payment has missed a flight because a sales centre has had long queues of people requiring various services. It will be appreciated that the present system overcomes such a problem and allows a late passenger to pay his excess baggage payment quickly even if there are a large number of other people waiting to use the sale centre 42. In addition, the central computer gives priority to passengers making excess baggage payments according to their class of travel.

Once again, any information displayed by the touch sensitive screen 54 of the voucher dispenser 52 can be displayed in a number of different languages as specified by the person using the touch sensitive screen 54.

The foregoing describes only one embodiment of the first aspect of the present invention, and modifications, obvious to those skilled in the art, can be made thereto without departing from the scope of the present invention.

One embodiment of the second aspect of the invention will now be described by way of example only, with reference to FIG. 12, which shows a queue management system in operation.

The queue management system 2 which will be described is for use by an organisation which assists people to find employment, and comprises ten automated service devices 4, three staffed service points 6, a display device 8 and a first identification device 10. The queue management system is set up in an office 11 of the organisation as shown in the drawing.

Each client of the organisation is issued with a personal identification card on which the client's identity is recorded by means of a magnetic strip. On arriving at the office 11 of the organisation, the client starts at an information board 12 on which the first identification device 10 is mounted. The information board 12 is entitled “WHAT TO DO”, and displays written instructions on how to use the system. The client must first insert his personal identification card into the first identification device 10 in order, to identify himself to the system. The first identification device 10 is connected to a central computer (not shown) which controls the operation of the system and also records statistical information on the use of the system.

When the client inserts his personal identification card into the first identification device 10, the first identification device 10 determines the identity of the client, and informs the computer accordingly. The message is then displayed on a small screen 15 provided on the first identification device 10 informing the client that he has been correctly identified, and asking the client to provide information on what service is required. The client may then enter information, using a keypad 13 provided on the first identification device, specifying the service or services that he requires. For example, the client may choose whether to use one of the automated service devices 4 or to go to one of the staffed service points 6.

Alternatively, the client may specify what information he requires and the computer may decide whether the client needs to attend one of the staffed service points 6 or whether the information that the client requires can be obtained from one of the automated service device 4.

In either case, the computer checks whether the client is authorised to use the requested service and informs the client accordingly by means of information displayed on the screen 15.

In a further, non-illustrated embodiment of the queue management system 2, the first identification device 10 is provided with a visual display unit (VDU) for displaying information on how to use the system in a range of alternative languages, thus making the system readily accessible by people of different nationalities. The VDU can be provided with a touch sensitive screen for allowing the user to make selections and choices, and to request further information.

Once the client has correctly identified himself and made the relevant choices at the first identification device 10 using the keypad 13, and the computer has checked that the client is authorised to use the requested service, the first identification device 10 dispenses a numbered ticket to the client, and the client takes a seat in the waiting area 14. The tickets can be provided with a bar code. The waiting area 14 contains a number of chairs 16 which face the display device 8 which is suspended from the ceiling of the office 11.

Alternatively, if the person is a new client who does not yet have a personal identification card, or an existing client who has lost his identification card or whose identification card has expired, he presses a specified button on the keypad 13 which causes the computer to register the fact that the person needs to be issued with a personal identification card. The first identification device 10 then issues the person with a ticket in the normal way, but the computer makes a note that that person should be directed, by the display device 8, to the one of the staffed service points 6 where he can be issued with a personal identification card.

The information displayed by the display device 8 is controlled by the computer, and is used to direct clients from the waiting area 14 to the automated service devices 4 and staffed service points 6, which are numbered using position markers 18.

As can be seen from the drawing, the display device 8 displays both the ticket number and the number of the appropriate position marker 18.

It will be seen from the drawing that some of the automated service devices 4 are mounted at standing height for use by clients while standing, and others are mounted at sitting height for use by clients while sitting in a chair or wheel chair.

All of the automated service devices 4 are connected to the computer, and the computer is thus aware of which automated service devices 4 are in use, and which are available, at any given time. The computer is therefore able to direct clients to free service devices 4 as they become available.

However, the computer need not necessarily direct clients to free service devices 4 in the same order in which the clients identified themselves at the first identification device 10. For example, if a client indicated at the first identification device 10 that he was disabled and in a wheel chair, the computer can wait until one of the sitting height service devices 4 becomes available, rather than directing that client to the first available standing height service device 4. Furthermore, different service devices 4 can perform different, specialised functions, in which case the computer directs clients to the appropriate service devices 4, rather than to the first available service devices 4.

Similar considerations apply to the staffed service points 6. Each staffed service point 6 is provided with a button (not shown) which is connected to the computer, and which the staff member 20 operates when his service point 6 becomes free. The computer then decides which client to direct to the free service point 6.

Instead of using such buttons at the staffed service points 6, each staffed service point can be provided with a computer keyboard and/or mouse and computer VDU (not shown), to enable the staff member 20 to monitor the operation of the queuing system and/or to feed information to the computer or computers controlling the system. This is particularly appropriate if the system is controlled by, or incorporates, a local Area Network. The staff members 20 can by use of a pointing device such as a mouse or cursor keys or individual keys on the keyboard identify to the system that they wish to page a client or recall a client for further service. In the case of paging, initially the staff member would move a cursor or pointer or press an appropriate button and inform the system that that staff member 20 wishes to page a client to that particular position within the office or working environment. When the client or customer to be served arrives for service the respective serving staff member 20 would press a button appropriate to inform the system that a service is being commenced. At the end of such service the staff member can press an appropriate button to identify the end of that service or the commencement of another service or that they are leaving their position etc. By similar means, a staff member 20 can log on to the queuing system and log off at the end of their duty time. Further, by this facility the serving staff members 20 can look into the recall registers of the system to establish individual clients' ticket numbers who require further onwards service. Similarly, any staff member can access the system statistics. Monitor screens using touchscreen technology with touch sensitive screens or similar devices that perform a similar role can also be employed. All of the monitor screen can be devoted to the queue management information whilst such facility is required being able to revert to other uses of the computer and the Local Area Network as appropriate in intervening times e.g. during serving of an individual client where a client's personal records or other information may need to be brought up on screen from an internal database from a Local Area Network fileserver or a linking through modem or other means to a mainframe located elsewhere. Alternatively, it is possible to devote a portion of the screen to queue management operations whilst the balance of the screen is used for normal office access to whatever information might be maintained by the office in conjunction with the queue management system or independently of the queue management system. A further variation of this arrangement is a combination of a separate keypad with onscreen information in relation to the queue management operations or the inversion of this arrangement being identifiable keys on the Local Area Network computer or terminal keyboard with ticket number displays separately provided by way of liquid crystal or light emitting diode displays etc located on or near or in view of the staff member 20 operating at that position. An advantage of these variations is the ability to enter client names or other information such as the type of service that a particular client has required or what documents are being lodged as part of a client's application, and how many documents are being lodged.

Each service device 4 is provided with a visual display unit (VDU) 22 for displaying information to the client. The client may interact with the service device 4 by means of any suitable interface, including a touch sensitive screen, or a keyboard, or keypad. This provides many advantages. For example, the information displayed by the VDU 22 can be displayed in one of a large range of languages, at the request of the client, thus allowing the system to be used by people of many different nationalities without the need to employ specialist translators. Furthermore, the VDUs 22 can be used for a variety of purposes other than providing the client with requested information. For example, psychometric or literacy testing can be carried out using the VDUs 22.

An advantage of the system is that, because the computer is aware of the identity of the client, specific information relating to the client can be displayed by the service devices 4. For example, the computer can control the service device 4 to provide information on only those jobs which relate to specific qualifications or are located in specific areas which are suitable for the particular client using the service device 4.

Each service device 4 is also provided with a respective second identification device 24 adapted to receive the personal identification card, or the bar coded ticket, of the client in order to check that the client trying to use the service device 4 has been directed to the service device 4 by the display device 8. If a client goes to the wrong service device 4, the computer instructs the service device 4 to ask the client to proceed to the correct service device 4, or to return to the waiting area 14.

Each service device 4 is also provided with a respective printing device (not shown) for providing the client with a hard copy of information displayed on the VDU 22, at the request of the client.

In an alternative, non-illustrated embodiment of the queue management system 2, the first identification device 10 is provided with a coin and note validating device for accepting a payment from clients arriving at the information board 12. The amount charged for use of the service can be a flat fee, or can depend on the identity of the client. In the latter case, the client must first identify himself and/or specify the service required at the first identification device 10, and then he will then be informed by the screen 15 of the amount, if any, required.

The foregoing describes only one embodiment of the second aspect of the present invention and modifications, obvious to those skilled in the art, can be made thereto without departing from the scope of the present invention.

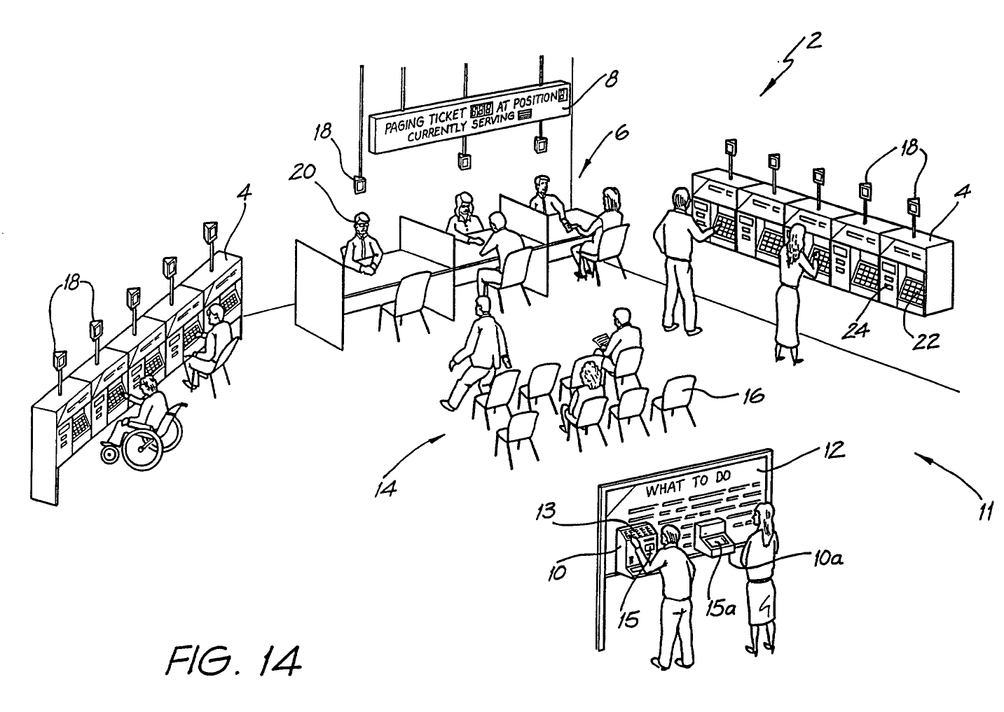

An embodiment of the third aspect of the invention will now be described, by way of example only, with reference to FIG. 13 of the accompanying drawings, which shows an automated VISA issuing device 2.

The issuing device 2 is provided with a passport insertion slot 4 into which a person wishing to obtain a VISA must insert his or her passport. Also provided on the front of the issuing device 2 is a coin slot 6 for receiving coins, and a note validation slot 8 for receiving bank notes, which may be required if there is a fee attached to the issue of the VISA. Below those slots is a card slot 10 adapted to receive a banking card, such as a credit card, or smart card, in order to provide an alternative form of payment.

At the top of the issuing device 2, there is provided a camera 12 for producing an image of the applicant on a screen 14. Although only one camera 12 is shown, there may be a number of cameras, including for example stereo of multiple camera lenses. Lights 16 are also provided for illuminating the face of the applicant.

Below the screen 14, there is provided a keyboard 18, which allows the applicant to input the necessary information, for example in response to questions displayed on the screen 14. As an alternative to the keyboard 18, the screen 14 may be touch sensitive. Beside the keyboard 18 there is provided a signature device 20 for obtaining a signature from the applicant. The signature device 20 moves out a piece of paper or card 22 which the applicant is required to sign, and then retracts the paper or card 22 back into the issuing device 2 in order to prevent fraud. It will be appreciated that by requiring an original signature on the paper or card 22, the issuing device 2 avoids the possibility of an applicant presenting an unauthorised copy of some other persons signature to the issuing device 2 for verification.

The issuing device 2 carries out various checks in order to determine whether or not to issue the applicant with a VISA. In particular, the issuing device 2 compares the signature on the applicant's passport with the signature of the applicant on the paper or card 22. The issuing device 2 also compares the image of the applicant's face obtained via the camera 12, and displayed on the screen 14, with an image of the applicant stored in an appropriate database, or with an image of the applicant obtained from a photograph on the applicant's passport. It will be appreciated that these procedures involve conventional methods of digitising and comparing images using appropriate software.

If the issuing device 2 determines that the applicant is entitled to a VISA, the issuing device 2 either presents the applicant with a printed authorisation, or automatically stamps, or applies a sticker to, the applicants passport. In the case of issuance of a printed authorisation, the applicant must take the printed authorisation to the relevant authorised officer in order to obtain a VISA. The issuing device 2 is linked to a central records facility by a local area network, wide area network or modem as appropriate. It will be appreciated that this provides the ability to automatically detect certain persons, such as known terrorists. Similar, if the issuing device 2 determines that fraud is likely, appropriate members of the VISA issuing organisation may be alerted automatically.

It is also possible to use the issuing device 2 in a semi-automatic manner, in which images of the passport and of the applicant are transmitted in real time to an officer undertaking comparison. Voice communication can be provided between the officer and the applicant, who may be located at separate locations in a building, or even in separate countries.

The issuing device 2 can also perform the function of taking passport or similar photographs upon payment of a fee. In this case, the applicant or customer requiring such a photograph has the opportunity to check his or her personal appearance and presented view by observing the image on the screen 14 before activating the cameras digitised storage ability by the pressing of a button or key as appropriate. Alternatively, there may be two separate cameras, one being the electronic imaging camera 12 which provides an image on the screen 14 (which can be a conventional cathode ray display or a liquid crystal display), and the other being a camera which exposes conventional film in order to provide the customer with prints. In such a case, the respective lenses are preferably placed immediately adjacent each other in order to obtain the closest correspondence of views. Alternatively, the lenses can be co-located via mirrors, or accept incident light reflected from the subject through a single lense. For example, a twin lense reflex arrangement can be used to enhance the image definition, personal appearance and/or clarity means can be provided to allow the customer to adjust the brightness of the facial illumination device and/or the direction or directions from which light from the illumination device illuminates the subject's face.

The issuing device 2 can also be provided with a hand-print profile recording device which records, measures and compares the shape and size of a hand. Additionally or alternatively, a finger print comparison device or other means of comparing physical attributes of a VISA applicant with information contained in their passport or other records, can also be provided.

One embodiment of the fourth aspect of the invention will now be described by way of example only, with reference to FIG. 14, which shows a queue management system in operation.

The queue management system 2 which will be described is for use by an organisation which assists people to find employment, and comprises ten automated service devices 4, three staffed service points 6, a display device 8, a first identification device 10, and a multilingual instruction display device 10a. The queue management system is set up in an office 11 of the organisation as shown in the drawing.

Each client of the organisation is issued with a personal identification card on which the client's identity is recorded by means of a magnetic strip. On arriving at the office 11 of the organisation, the client starts at an information board 12 on which the first identification device 10 and multilingual instruction display device 10a are mounted. The information board 12 is entitled “WHAT TO DO”, and displays brief written instructions in different languages directing the user to the first identification device 10 and the multilingual instruction display device 10a. The client must first insert his personal identification card into the first identification device 10 in order to identify himself to the system. The first identification device 10 is connected to a central computer (not shown) which controls the operation of the system and also records statistical information on the use of the system.

When the client inserts his personal identification card into the first identification device 10, the first identification device 10 determines the identity of the client, and informs the computer accordingly. The message is then displayed on a small screen 15 provided on the first identification device 10 informing the client that he has been correctly identified, and asking the client to provide information on what service is required. The client may then enter information, using a keypad 13 provided on the first identification device, specifying the service or services that he requires. For example, the client may choose whether to use one of the automated service devices 4 or to go to one of the staffed service points 6.

Alternatively, the client may specify what information he requires and the computer may decide whether the client needs to attend one of the staffed service points 6 or whether the information that the client requires can be obtained from one of the automated service devices 4.

In either case, the computer checks whether the client is authorised to use the requested service and informs the client accordingly by means of information displayed on the screen 15.

The multilingual instruction display device 10a is located beside the first identification device 10, and is provided with a visual display unit (VDU) for displaying information on how to use the system in a range of alternative languages, thus making the system readily accessible by people of different nationalities. The VDU is provided with a touch sensitive screen 15a for allowing the user to make selections and choices, and to request further information. For example, the user can specify in which language information is to be displayed on the touch sensitive screen. The touch sensitive screen can be of any suitable type, and can, for example, operate by means of the interruption of crossing infrared beams located just above the surface of the screen.

In a further, non-illustrated embodiment of the invention, the first identification device 10 and the multilingual instruction display device 10a are combined to form a single unit, so that use of the multilingual instruction display device 10a is conditional on the user first identifying himself. In this case, the small screen 15 and keypad 13 can be replaced by the touch sensitive screen 15a.

Once the client has correctly identified himself and made the relevant choices at the first identification device 10 using the keypad 13, or the touch sensitive screen 15a as the case may be, and the computer has checked that the client is authorised to use the requested service, the first identification device 10 dispenses a numbered ticket to the client, and the client takes a seat in the waiting area 14. The tickets can be provided with a bar code. The waiting area 14 contains a number of chairs 16, which face the display device 8 which is suspended from the ceiling of the office 11.

Alternatively, if the person is a new client who does not yet have a personal identification card, or an existing client who has lost his identification card or whose identification card has expired, he presses a specified button on the keypad 13 (or touch sensitive screen 15a) which causes the computer to register the fact that the person needs to be issued with a personal identification card. The first identification device 10 then issues the person with a ticket in the normal way, but the computer makes a note that that person should be directed, by the display device 8, to the one of the staffed service points 6 where he can, for example, be issued with a personal identification card. Alternatively, the person can be directed by the display device 8 to one of the automated service devices 4. It will be appreciated that the first identification device 10 can therefore be regarded, in a general sense, as an arrival device which must be operated by a person before using the system. That is to say, in the case of a person who does not have an identification card the person is still directed by the display device 8, even though the person has not been identified. In addition, it should be appreciated that a member of staff could be provided to operate the arrival device on behalf of clients wishing to use the system.

The information displayed by the display device 8 is controlled by the computer, and is used to direct clients from the waiting area 14 to the automated service devices 4 and staffed service points 6, which are numbered using position markers 18. As can be seen from the drawing, the display device 8 displays both the ticket number and the number of the appropriate position marker 18.

It will be seen from the drawing that some of the automated service devices 4 are mounted at standing height for use by clients while standing, and others are mounted at sitting height for use by clients while sitting in a chair or wheel chair.

All of the automated service devices 4 are connected to the computer, and the computer is thus aware of which automated service devices 4 are in use, and which are available, at any given time. The computer is therefore able to direct clients to free service devices 4 as they become available.

However, the computer need not necessarily direct clients to free service devices 4 in the same order in which the clients identified themselves at the first identification device 10. For example, if a client indicated at the first identification device 10 that he was disabled and in a wheel chair, the computer can wait until one of the sitting height service devices 4 becomes available, rather than directing that client to the first available standing height service device 4. Furthermore, different service devices 4 can perform different, specialised functions, in which case the computer directs clients to the appropriate service devices 4, rather than to the first available service devices 4.

Similar considerations apply to the staffed service points 6. Each staffed service point 6 is provided with a button which is connected to the computer, and which the staff member 20 operates when his service point 6 becomes free. The computer then decides which client to direct to the free service point 6. As described above, such buttons can be replaced by a computer keyboard and/or mouse, and a computer VDU, which can be touch sensitive. This is particularly appropriate if a Local Area Network is used, as described above.

Each service device 4 is provided with a visual display unit (VDU) 22 for displaying information to the client. The client may interact with the service device 4 by means of any suitable interface, including a touch sensitive screen, or a keyboard, or keypad. This provides many advantages. For example, the information displayed by the VDU 22 can be displayed in one of a large range of languages, at the request of the client, thus allowing the system to be used by people of many different nationalities without the need to employ specialist translators. Furthermore, the VDUs 22 can be used for a variety of purposes other than providing the client with requested information. For example, psychometric or literacy testing can be carried out using the VDUs 22.

An advantage of the system is that, because the computer is aware of the identity of the client, specific information relating to the client can be displayed by the service devices 4. For example, the computer can control the service device 4 to provide information on only those jobs which relate to specific qualifications or are located in specific areas which are suitable for the particular client using the service device 4.

Each service device 4 is also provided with a respective second identification device 24 adapted to receive the personal identification card, or the bar coded ticket, of the client in order to check that the client trying to use the service device 4 has been directed to the service device 4 by the display device 8. If a client goes to the wrong service device 4, the computer instructs the service device 4 to ask the client to proceed to the correct service device 4, or to return to the waiting area 14.

Each service device 4 is also provided with a respective printing device (not shown) for providing the client with a hard copy of information displayed on the VDU 22, or other information, at the request of the client.

In an alternative, non-illustrated embodiment of the queue management system 2, the first identification device 10 is provided with a coin and note validating device for accepting a payment from clients arriving at the information board 12. The amount charged for use of the service can be a flat fee, or can depend on the identity of the client or the service required. In the latter case, the client must first identify himself and/or specify the service required at the first identification device 10, and then he will then be informed by the screen 15 of the amount, if any, required.

The foregoing describes only one embodiment of the fourth aspect of the present invention and modifications, obvious to those skilled in the art, can be made thereto without departing from the scope of the present invention.

For example, the queue management system can comprise only staffed service points 6, and no automated service devices 4.

Any of the queue managements systems described herein can be used to control access into a private or administrative office or interview room or similar secure environment through a two door “Man Trap” or similar access device.

Many offices, particularly in embassies and other environments have a two door sequential access facility with an airlock in between the two doors such that a person can be provided with access from a public area through the first door into the airlock. When this first door is closed a further door can be opened to allow onwards progress by the person being admitted to the secure area. However, this facility prevents unauthorised people following the person through a single door to perhaps enter without authorisation.

The queue management invention provides additional and very special features to the existing concept of “man trap” type two door sequential access paths.

The outer door being the nearest one to the public area, say a waiting room or similar environment, can be equipped as part of the queue management system such that when a client's ticket number is being paged it may be paged to the “man trap” security access passage.

Such door to the public access area may be equipped with a number identifier or similar device which may be visual, aural or both to guide a person to service at that door. For the currency of the paging time span or some other controllable time frame selectable in the controls for the queue management system such door would be automatically unlocked to allow the person or persons passage through the first door into the air lock.

When the outer door is closed behind the person or persons entering the airlock, the staff member on the secure side of the secondary door can press a release button to allow the visitors or clients to pass through the second door into the secure area.

Normally, such inner door has security glass so that a staff member on the secure side can see or observe the incoming clients. However, such facility may be implemented by closed circuit television or other means, such as one-way glass.

Alternatively, the secondary door can be actuated by the staff member pressing the serve button as part of the queue management system to identify that the correct client is being taken into the secure area for interview or otherwise as appropriate.

The normally fitted security glass in the secondary entrance door facilitates a client showing their ticket number through the glass before the staff member presses the serving button or actuating the door lock release by other means to allow passage into the secure area by the incoming client or clients.

As a further variation, the client can have in hand a ticket issued by the queue management system with bar-code to provide access by identifying that particular ticket at the entrance door as further confirmation at the secondary door before passage would be allowed into the secure area. Other means, such as smart-card or magnetic encoded cards, could be similarly employed.

Furthermore, in any of the queue management systems described herein, instead of wires or other conductors being used in the implementation of the queue management system, the various necessary devices within the queue management system can communicate with each other via infra-red or other radiation such as lasers etc, or via radio transmission on discreet frequencies in the local environment. Alternatively, such devices may communicate as part of a cohesive queue management system by implementing additive or subtractive voltage signals superimposed upon the natural sine-wave wave form of the reticulated electricity supply within an office such that the devices could readily plug in to the nearest general power outlet (power point) and apply and retrieve their various signals from the electricity supply cabling. In the case of infra-red or similar communications the benefit in the use of this technology in a system would be the avoidance of complex cable runs to convey the signals through difficult to get at structure or portions of a building. The significant benefits provided by radio propagation and reception within a particular office or similar environment are the complete freedom within that space where the signals can be transmitted and/or received not requiring any cabling to link the various necessary components together as part of the system and also the freedom for particular officers or staff members to carry with them their particular operational control units that communicate with other componentry within the overall system.

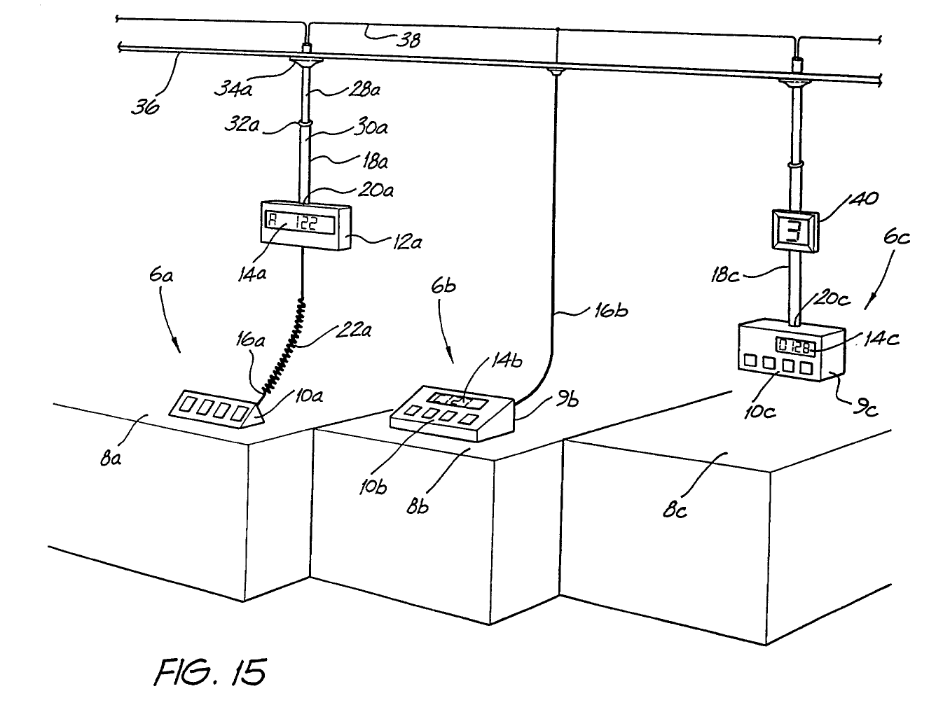

An embodiment of the fifth aspect of the invention will now be described, by way of example only, with reference to FIG. 15 of the accompanying drawings.

FIG. 15 shows three adjacent staffed service points 6a, 6b and 6c which are provided with a queue management system for directing clients to appropriate staffed service points at appropriate times in any of the manners described above. Each service point 6 is provided with a respective desk 8a, 8b, 8c operated by a respective staff member (not shown).

Service point 6a is provided with a paging device comprising a control unit 10a and a display unit 12a provided with a display 14a. The control unit 10a is used by the staff member to page clients, and to send other relevant information to a computer controlling the queue management system. The display 14a displays the ticket number of the next client to the staff member.

The control unit 10a and display unit 12a are connected to the rest of the queue management system by a cable 16a, the upper portion of which is supported within a guide conduit 18a. The display unit 12a is supported at the lower end 20a of the guide conduit 18a. The cable 16a, a portion 22a of which may be coiled, and a portion 24a of which may be enclosed within a flexible outer sheath 26a, connects the display unit 12a with the control 10a.

The display unit 12a is rotatably mounted to the guide conduit 12a so as to be able to swivel about a vertical axis to suit the position of the staff member operating the service point 6a. In addition, the guide conduit 18a is formed from upper and lower parts 28a and 30a respectively, which are telescopically connected together to form adjustable friction joint 32a which allows the height of the display unit to be adjusted. A bracket 34a connects the upper part 22a of the guide conduit 18a to the sealing 36 above the service points 6a, 6b and 6c. The upper part 28a of the guide conduit 18a extends through the sealing 36a, and it feed at its upper end by wires 38 which combine to form the cable 16a.

The second service point 6b is provided with a paging device 9b which combines a control unit 10b with a display 14b. The paging device 9b is connected by a cable 16b to the wires 38 above the sealing 36, without the aid of a guide conduit. However, a guide conduit can be used to guide the upper part of the cable 16b, in the manner described in relation to the first service point 6a.

The third service point 6c is provided with a paging device 9c which incorporates a control unit 10c and a display 14c.

The paging device 9c is rotatably mounted at the lower end 20c of a guide conduit 18c, in the manner described in relation to the first service point 6a. The guide conduit 18c is again telescopically adjustable, and also supports a number of identifier 14 which identifies the third service point 6c to users of the system. In this example, the third service point 6c is service point number 3, as indicated by the number identifier 40.

Embodiments of the sixth aspect of the invention will now be described, by way of example only, with reference to the accompanying drawings, in which:

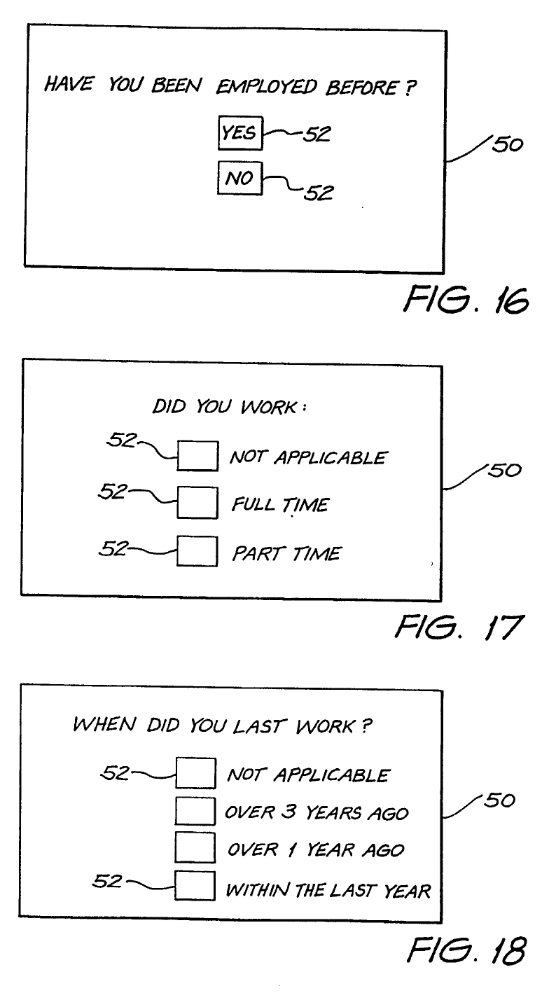

FIGS. 16 to 18 show three consecutive screens used in a method of literacy assessment; and

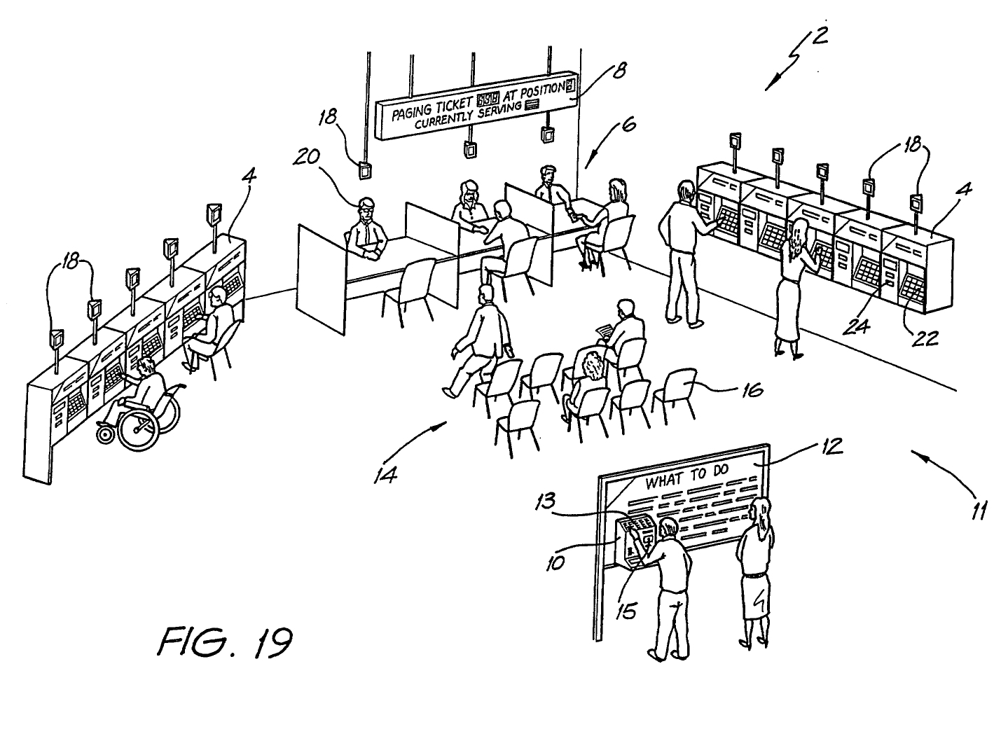

FIG. 19 shows a client management system incorporating the assessment method.

The literacy assessment method is capable of being carried out on an ordinary personal computer having a touch sensitive screen 50, shown in FIGS. 16 to 18. The touch sensitive screen may be of any type, including a type using a crossing beams of electromagnetic radiation located just above the surface of the screen.

The screen 50 is controlled by the computer to present a person to be tested with a series of questions, examples of which are shown in FIGS. 16 to 18. When the first question has been answered by pressing one of the regions 52, labelled Yes and No, the screen 50 displays the next question, shown in FIG. 17, and so on for subsequent questions. The system also has the capability to determine what questions are subsequently asked on the basis of answers given to previous questions. In this way, the answers given to questions can determine what “path” the client follows through a branching network of questions.

The computer records not only the answers given to each question, but also the time taken by the person to answer each question. This provides useful additional information, which can be used in an analysis of the answers given carried out by the computer. Furthermore, if the person fails to answer a question within a given predetermined time period, the screen 50 automatically moves on to the next question. The predetermined time interval for each question can be adjusted in accordance with, for example, the difficulty of each question.

In a further (non-illustrated) embodiment, some or all of the questions, together with their associated answers, are displayed simultaneously on the screen 50, and the person is allowed to answer the questions in the order which he chooses. In this case, it will be appreciated that the order in which the person chooses to answer the questions may also provide valuable additional information, which can be included in the analysis carried out by the computer. For example, it can be expected that difficult questions would often be attempted last, and the order in which the questions are attempted is, therefore, likely to give some indication of the order of difficulty which the person finds with the questions.

Furthermore, in the case of both the serial method and the simultaneous method described above, the computer is adapted to stop the test in the event of an answer being given to a question which is inconsistent with an answer already given to a different question. Thus, in the exemplary questions shown in FIGS. 16 to 18, if the person answered no to the first question, namely, “Have you been employed before?”, and subsequently gave the answer “Over 3 years ago” to the third question, namely “When did you last work?”, the computer would stop the test. That is because, having established that the person may have a literacy problem, it would be unnecessary to ask further questions.

It has been found that people with literacy problems will often answer questions of the type shown in FIGS. 16 to 18 by simply selecting, for example, the top button for every question, or some other button, such as the middle button or bottom button. The answers to the questions are therefore arranged in such a way that anyone adopting such an approach will necessarily give inconsistent answers. Thus, for example, if the person selects the bottom button (No) on the first question, and then also selects the bottom button (Part Time) on the second question an inconsistency will arise which suggests that the person may have a literacy problem. Similarly, an inconsistency will arise if the person selects the top button for each of the first two questions.

It will also be noticed from FIGS. 16 to 18 that each question is provided with a different number of answers. Thus, for example, it is impossible for a person to simply choose the centre button for each question, since, in the examples given, questions 1 and 3 have no centre button. This feature also helps to overcome the problem of people of poor literacy simply selecting the same button for each question.

A further aspect of the invention will now be described, by way of example only, with reference to FIG. 19, which shows a client management system in operation. In this exemplary embodiment, the client management system is in the form of a queue management system 2.

The queue management system 2 which will be described is for use by an organisation which assists people to find employment, and comprises ten automated service devices 4, three staffed service points 6, a display device 8 and a first identification device 10. The queue management system is set up in an office 11 of the organisation as shown in the drawing.

Each client of the organisation is issued with a personal identification card on which the client's identity is recorded by means of a magnetic strip. On arriving at the office 11 of the organisation, the client starts at an information board 12 on which the first identification device 10 is mounted. The information board 12 is entitled “WHAT TO DO”, and displays written instructions on how to use the system. The client must first insert his personal identification card into the first identification device 10 in order to identify himself to the system. The first identification device 10 is connected to a central computer (not shown) which controls the operation of the system and also records statistical information on the use of the system.

When the client inserts his personal identification card into the first identification device 10, the first identification device 10 determines the identity of the client, and informs the computer accordingly. The message is then displayed on a touch sensitive screen 15 provided on the first identification device 10 informing the client that he has been correctly identified, and asking the client to provide information on what service is required. The client may then enter information, by touching/pressing the touch sensitive screen 15, specifying the service or services that he requires. For example, the client may choose whether to use one of the automated service devices 4 or to go to one of the staffed service points 6.

Alternatively, the client may specify what information he requires and the computer may decide whether the client needs to attend one of the staffed service points 6 or whether the information that the client requires can be obtained from one of the automated service device 4.

In either case, the computer checks whether the client is authorised to use the requested service and informs the client accordingly by means of information displayed on the screen 15.

The screen 15 is controlled by the computer to ask the client a series of questions of the type described above with reference to FIGS. 18 to 16 in order to detect whether the client may have a literacy problem. It will be appreciated that, because the questions relate to the service which is being provided, the client will not necessary be aware that his literacy is being assessed by the system. If the computer detects, on the basis of the answers provided by the client, that the client may have a literacy problem, the computer makes note that the client should be directed to a particular staffed service point 6. Additionally or alternatively, the member of staff operating the staffed service point 6 to which the client is directed can be informed by the computer that the client may have a literacy problem. The member of staff can, for example, be informed by means of information displayed on a VDU located at the staffed service point 6, or by means of information printed on the ticket issued to the client. It will be appreciated that this information is of particular importance in helping the client to find an appropriate form of employment. Thus, all of the principles described above with reference to FIGS. 16 to 18 can be applied to the operation of screen 15, so that screen 15 can, in effect, operate as an assessment device.

In a further, non-illustrated embodiment of the queue management system 2, the first identification device 10 is provided with a visual display unit (VDU) for displaying information on how to use the system in a range of alternative languages, thus making the system readily accessible by people of different nationalities. The VDU can be provided with a touch sensitive screen for allowing the user to make selections and choices, and to request further information.

Once the client has correctly identified himself and made the relevant choices at the first identification device 10 using the touch sensitive screen 15, and/or a keypad 13, and the computer has checked that the client is authorised to use the requested service, the first identification device 10 dispenses a numbered ticket to the client, and the client takes a seat in the waiting area 14. The tickets can be provided with a bar code. The waiting area 14 contains a number of chairs 16 which face the display device 8 which is suspended from the ceiling of the office 11.

Alternatively, if the person is a new client who does not yet have a personal identification card, or an existing client who has lost his identification card or whose identification card has expired, he presses a specified button on the keypad 13 or the touch sensitive screen 15 which causes the computer to register the fact that the person needs to be issued with a personal identification card. The first identification device 10 then issues the person with a ticket in the normal way, but the computer makes a note that that person should be directed, by the display device 8, to the one of the staffed service points 6 where he can be issued with a personal identification card.

The information displayed by the display device 8 is controlled by the computer, and is used to direct clients from the waiting area 14 to the automated service devices 4 and staffed service points 6, which are numbered using position markers 18. As can be seen from the drawing, the display device 8 displays both the ticket number and the number of the appropriate position marker 18.

It will be seen from the drawing that some of the automated service devices 4 are mounted at standing height for use by clients while standing, and others are mounted at sitting height for use by clients while sitting in a chair or wheel chair.

All of the automated service devices 4 are connected to the computer, and the computer is thus aware of which automated service devices 4 are in use, and which are available, at any given time. The computer is therefore able to direct clients to free service devices 4 as they become available.

However, the computer need not necessarily direct clients to free service devices 4 in the same order in which the clients identified themselves at the first identification device 10. For example, if a client indicated at the first identification device 10 that he was disabled and in a wheel chair, the computer can wait until one of the sitting height service devices 4 becomes available, rather than directing that client to the first available standing height service device 4. Furthermore, different service devices 4 can perform different, specialised functions, in which case the computer directs clients to the appropriate service devices 4, rather than to the first available service devices 4.

Similar considerations apply to the staffed service points 6. Each staffed service point 6 is provided with a button which is connected to the computer, and which the staff member 20 operates when his service point 6 becomes free. The computer then decides which client to direct to the free service point 6. As described above, such buttons can be replaced by a computer keyboard and/or mouse, and a computer VDU, which can be touch sensitive. This is particularly appropriate if a Local Area Network is used, as described above.

Each service device 4 is provided with a visual display unit (VDU) 22 for displaying information to the client. The client may interact with the service device 4 by means of any suitable interface, including a touch sensitive screen, or a keyboard, or keypad. This provides many advantages. For example, the information displayed by the VDU 22 can be displayed in one of a large range of languages, at the request of the client, thus allowing the system to be used by people of many different nationalities without the need to employ specialist translators. Furthermore, the VDUs 22 can be used for a variety of purposes other than providing the client with requested information. In particular, psychometric, literacy and/or other testing can be carried out using the VDUs 22. Any or all of the principles and features described above in relation to FIGS. 16 to 18 can be used in any testing which is carried out at the service devices 4.

An advantage of the system is that, because the computer is aware of the identity of the client, specific information relating to the client can be displayed by the service devices 4. For example, the computer can control the service device 4 to provide information on only those jobs which relate to specific qualifications or are located in specific areas which are suitable for the particular client using the service device 4.

Each service device 4 is also provided with a respective second identification device 24 adapted to receive the personal identification card, or the bar coded ticket, of the client in order to check that the client trying to use the service device 4 has been directed to the service device 4 by the display device 8. If a client goes to the wrong service device 4, the computer instructs the service device 4 to ask the client to proceed to the correct service device 4, or to return to the waiting area 14.

Each service device 4 is also provided with a respective printing device (not shown) for providing the client with a hard copy of information displayed on the VDU 22, at the request of the client.

In an alternative, non-illustrated embodiment of the queue management system 2, the first identification device 10 is provided with a coin and note validating device for accepting a payment from clients arriving at the information board 12. The amount charged for use of the service can be a flat fee, or can depend on the identity of the client. In the latter case, the client must first identify himself and/or specify the service required at the first identification device 10, and then he will then be informed by the screen 15 of the amount, if any, required.

The foregoing describes only preferred embodiments of the sixth aspect of the present invention and modifications, obvious-to those skilled in the art, can be made thereto without departing from the scope of the present invention.

A further embodiment of the invention provides for the first aircraft scheduled to depart to be allocated a range of voucher numbers starting at 1, with an upper limit of 500 (though may be greater or lesser). This allows for say a Boeing 747 with 396 seats. The second flight scheduled to depart will be allocated a Voucher number range stating at 501. The third from 1001. The fourth, from 1501 and so on. If and when aircraft capacities grow beyond seating for 500, then without departing from the invention, the individual ranges can grow. In the same way, without departing from the invention, less than 500 may be used as a range or even varying ranges according to aircraft capacities may be used. Say the first aircraft scheduled to depart has 186 seats. It may be assigned a voucher range from 1 to 200. The next aircraft may have 396 seats. It may be assigned the range from 201 to 600. The third aircraft may have a capacity of 324. It may be assigned a range from 601 to 1200 and so on. It is felt by the inventor that an overall aggregate of individual aircraft related ranges up to 9,999 will be generally adequate (though not any finite limit). This desirably limits the number of digits to be displayed in relation to any voucher to four. At this point, aircraft with passengers' vouchers starting at 1 should have already departed. If the aircraft has left the gate, but is still not airborne, this does not matter, because passengers with vouchers starting from 1 will have already boarded. If an aircraft cannot yet commence boarding, passengers may still be checked in. If a flight is cancelled after vouchers are issued, where baggage cannot be accepted until alternative seating is organized on other flights, then a supervisor with access rights to the system main control PC, may selectively quarantine the outstanding voucher range so that those vouchers in the possession of the passengers for the cancelled flight remain valid for their paging and/or transfer as alternative travel arrangements and/or overnight accommodation arrangements are made. The system will then automatically skip over the quarantined numerical range. For example; aircraft voucher range commencing at 5501 has been quarantined because of an aircraft serviceability problem. In the re-use of the Voucher ranges, after re-using the range starting at voucher 5000, the next range automatically selected by the system starts at 6001, leaving those passengers with vouchers starting at 5501 with valid, usable vouchers as their predicaments are attended to; with no chance of mistakenly responding to check-in paging for a flight which might otherwise be re-using the numerical sequence of the cancelled flight. When passengers for the cancelled flight have all been attended to, the quarantined numerical range becomes re-usable. In dealing with such baulked passengers, the invisible transfer part of the invention may be used extensively in transparently guiding passengers to check-in counters for another flight, another airline's check-in counters or to crisis solution desks for hotel/transportation/complimentary meal coupon issue etc.

In a further embodiment, there is provided a check in guidance system for guiding passengers who are checking in to a transport service and at least one check in station each operated by a check-in station operator, the check-in guidance system comprising:

passenger registration means at which passengers who wish to check in to the transport service register their arrival in the transport departure environment, and where passengers input information relating to their travel requirements;

entitlement voucher dispensing means to dispense check-in vouchers to passengers according to their entitlement to be checked-in to the transport service;

a numerical voucher identifying scheme assigning distinctive groups of sequential numbers and allocating these to accord with the maximum seating capacity of the transport means such as aircraft, train, omnibus, ferry and the like;

visual and/or aural guidance means for providing guidance to passengers waiting for check-in by paging identified voucher numbers and advising them which respective check-in station to attend;

at least one check-in station service control operator means, located at a respective check-in station, at which check-in station operators manage their own service relating to the checking in of passengers, receive check-in management instructions and automatically receive prioritization information; and

computing means for automatically assessing the validity of passengers requested entitlements to obtain check-in vouchers and for sorting passengers who have registered their arrival in the transport departure environment into at least one automatic priority sequence according to the order in which they should be checked-in according to the urgency of departure and class of travel, and for controlling, in response to registration information received from the passenger registration means and the operator service control means, the guidance information means so as to direct passengers to the check-in stations in accordance with automatically variable priority sequences and to automatically prioritize the guidance for late-running passengers who have registered their arrival at the registration means but who have not yet been processed at a check-in station.

Preferably each operator service control means comprises a respective paging means which, on actuation by the corresponding check-in station operator, causes the next passenger in said variable priority sequence to be directed by the guidance means to the corresponding check-in station.

Preferably each operator service control means comprises service commencement means which, when actuated by the check-in station operator, informs the computing means that the check-in station operator is beginning to process the next passenger, so that the computing means knows who is being processed at any given check-in point at any given time.

Preferably each operator service control means comprises missing passenger means which, when actuated by the check-in station operator, informs the computing means that a passenger who has been directed to the check-in station by the guidance means has failed to attend at the check-in station, so that the computing means can decide whether, and if so when, to allow the passenger to be re-paged and to automatically upgrade or downgrade the prioritization in relation to that passenger's voucher according to the urgency of transport departure.

Preferably the operator service control means comprises interruption means which, when actuated by the check-in point station operator, informs the computing means that passenger who is currently being processed at that check-in station is to have processing interrupted and to be re-guided for resumption at a later stage at that check-in station or any other as determined automatically by the computing means.

Preferably the operator check-in control means comprises first re-guide means which, when actuated by the check-in station operator, informs the computing means that any and all passengers at that check-in station other than the passenger currently being processed are to be re-guided to one or more other check-in stations.

Preferably the operator service control means comprises second re-guidance means which, when actuated by the check-in station operator, informs the computing means that the passenger who is currently being processed is to be re-guided to another check-in point.

Preferably the operator check-in control means comprises operator check-in information means which makes available information to the check-in point operator under the control of the computing means and/or self-generated within the check-in control unit.

Preferably the operator check-in control information means makes available information which informs the check-in station operator which passengers, if any, have been paged to that check-in station but not yet commenced processing.

Preferably the passenger registration means comprises a machine reading device for machine reading information from media provided by passengers.

Preferably the passenger registration means is provided with a touch sensitive screen for allowing passengers to input information.

Preferably the touch sensitive screen displays at least one area, any and all such areas labelled with descriptive transportation identifying information, and the required registration process is achieved by touching each area in turn, the letter corresponding to each area being displayed on the screen each time the corresponding area is touched so that the user can view the information being entered.

Preferably the passenger registration means comprises a voucher dispenser for dispensing vouchers to passengers, each voucher bearing one or more identifying letters and/or numbers which can be used to guide passengers to the correct check-in stations and which can bear a guidance floor plan and/or diagram and/or instructions to guide passengers to a particular area and/or zone within the transport terminal environs in preparation for final guidance to a particular check-in station.

Preferably the vouchers dispensed by the voucher dispenser are provided with additional information to assist passengers through the check-in guidance system.

Preferably wherein the passenger registration means is adapted to receive and validate payment from passengers, and to dispense a voucher only if a required fee is paid.

Preferably said environment is provided with at least one separate station at which excess baggage payments are collected, and the check-in guidance system further comprises guidance means for guiding passengers under the control of the computing means, to direct each passenger who is waiting to make an excess baggage payment to a specified one of the stations, in an order determined by the computing means.

Preferably the stations provide other additional or alternative facilities in addition to collecting excess baggage payments, and the check-in guidance system further comprises a dispenser for dispensing vouchers to people who wish to use a station but do not require to make an excess baggage payment, each voucher bearing one or more identifying numbers and/or letters and/or symbols which can be used as guidance means to guide people to the stations.

Preferably the check-in guidance system automatically issues check-in vouchers from at least one voucher dispenser which operates with a special numerical scheme which comprises separate and separated groups of numerical sequences such that each transport unit (airplane, train, omnibus, ferry and/or the like) scheduled to depart has a group of voucher numbers corresponding to the maximum number of seats available plus an allowance for over-selling of the seating capacity allocated within an overall maximum numerical range.

Preferably the check-in guidance system issues check-in vouchers which bear bar codes and/or other machine readable images which passengers may present for reading or interrogation at check-in stations or elsewhere to record their arrival in a particular zone and/or area in the transport departure environment in readiness for final guidance to the check-in station for final processing.

Preferably the check-in guidance system further comprises registration means which incorporates at least one camera for capturing images of the passenger such images being still and or movie type and/or fingerprint images and or hand shape characteristics and/or eye retina characteristics and/or height/weight properties and/or otherwise which may be stored digitally in any storage medium to be held in storage for a selectable period of time or in perpetuity and which may be accessed by the Check-in system and/or other systems and/or parties with rights of access to such images retained in storage memory and which may be transmitted, retrieved and printed as required and/or made available to check-in operators being selectively or automatically presented on the check-in control unit and/or viewable on a PC or monitor or other display networked to the check-in guidance system and/or made available to the records systems for passport and/or visa/travel permission issuing authorities and/or be available for investigatory inquiries in the event of accident, incident and/or suspected acts of terrorism.

Preferably the check-in guidance system with registration means reads and/or captures images of passengers' travel documents which may include passport, visa, travel authority and/or the like and which may capture and store such image and/or information for simultaneous or later access and which may be transmitted to an internal or external database record system for verification that the passenger is permitted to be issued a voucher for check-in.

Preferably the check-in guidance system pre-pages passengers visually and/or aurally to be ready for attending a check-in station yet to be advised such that the passengers' voucher numbers are as selected by the computing means in order of their relative priority according to urgency of departure and/or First Class and/or Business class and/or the like and not necessarily the next in numerical sequence or based upon time of voucher issue.

Preferably the check-in guidance system uses paging means to visually and/or aurally guide passengers to respective check-in stations and/or upon approaching a check-in station advises the check-in station identifying means and/or provides visual information as confirmation that the passenger has attended the correct check-in station and/or has means for reading or interrogating a presented voucher to advise the passenger he or she has correctly attended and/or to advise the check-in guidance system and/or the check-in operator that the passenger has so attended.

Preferably the check-in guidance system has automatic zone selection for the paging of passengers whereby the paging of voucher numbers occurs in zones and/or areas according to the guidance directions appearing on the individual check-in vouchers or after each passenger has presented his or her voucher for reading or interrogation having arrived in a zone or area such that the paging of particular voucher numbers is limited to that area or zone within the transport departure environment.

Preferably the touch sensitive screen serves as a multilingual keyboard, wherein, after the user has specified the language required, the number of regions on the touch sensitive screen change if the required alphabet has a different number of letters.

1. A check-in guidance system for guiding passengers who are checking in to a transport service in an environment having a passenger waiting area and a plurality of check-in points operated by check-in point operators, the check-in guidance system comprising:
passenger information input means at which passengers who wish to check in to the transport service register their arrival, and input information relating to their travel requirements;
display means for displaying information to passengers waiting in said waiting area;
a plurality of operator information input means, each located at a respective check-in point, at which check-in point operators input information relating to the checking in of passengers; and
computing means for sorting passengers who have input information into said passenger information input means into a priority sequence according to the order in which they should be checked in, and for controlling, in response to information received from the passenger information input means and the operator information input means, the information displayed on the display means so as to direct passengers from the waiting area to the check-in points in accordance with said priority sequence.

2. A check-in guidance system as claimed in claim 1, wherein each operator information input means comprises a respective paging means which, on actuation by the corresponding check-in point operator, causes the next passenger in said priority sequence to be directed by the display means from the waiting area to the corresponding check-in point.

3. A check-in guidance system as claimed in claim 1 or 2, wherein each operator information input means comprises commence-serve means which, when actuated by the check-in point operator, informs the computing means that the check-in point operator is beginning to serve the next passenger, so that the computing means knows who is being served at any given check-in point at any given time.

4. A check-in guidance system as claimed in any preceding claim, wherein each operator information input means comprises no-show means which, when actuated by the check-in point operator, informs the computing means that a passenger who has been directed to the check-in point by the display means has failed to show at the check-in point, so that the computing means can decide whether, and if so when, to allow the passenger to be repaged.

5. A check-in guidance system as claimed in any preceding claim, wherein each operator information input means comprises on-duty means which, when actuated by the check-in point operator, informs the computing means that the check-in point is operational and can have passengers directed to it by the display means.

6. A check-in guidance system as claimed in any preceding claim, wherein the operator information input means comprises return-to-queue means which, when actuated by the check-in point operator, informs the computing means that the passenger who is currently being served at that check-in point is to be returned to the waiting area to await repaging.

7. A check-in guidance system as claimed in any preceding claim, wherein the operator information input means comprises first transfer-request means which, when actuated by the check-in point operator, informs the computing means that all passengers at that check-in point other than the passenger currently being served are to be transferred to one or more other check-in points.

8. A check-in guidance system as claimed in any preceding claim, wherein the operator information input means comprises second transfer-request means which, when actuated by the check-in point operator, informs the computing means that the passenger who is currently being served is to be transferred to another check-in point.

9. A check-in guidance system as claimed in any preceding claim, wherein the operator information input means comprises operator display means which displays information to the check-in point operator under the control of the computing means.

10. A check-in guidance system as claimed in any preceding claim, wherein the operator display means displays information which informs the check-in point operator which passengers, if any, have been paged but not yet served.

11. A check-in guidance system as claimed in any preceding claim, wherein the passenger information input means comprises a machine reading device for machine reading information from media provided by passengers.

12. A check-in guidance system as claimed in any preceding claim, wherein the passenger information input means is provided with a touch sensitive screen for allowing passengers to input information.

13. A check-in guidance system as claimed in claim 12, wherein the touch sensitive screen displays a plurality of areas, each area labelled with a respective letter of the alphabet, and the required information is input by touching each area in turn, the letter corresponding to each area being displayed on the screen each time the corresponding area is touched so that the user can view the information being entered.

14. A check-in guidance system as claimed in any preceding claim, wherein the passenger information input means comprises a voucher dispenser for dispensing vouchers to passengers, each voucher bearing one or more identifying letters and/or numbers which can be displayed by the display means to guide passengers to the correct check-in points.

15. A check-in guidance system as claimed in claim 14, wherein the vouchers dispensed by the voucher dispenser are provided with additional information to assist passengers through the check-in guidance system.

16. A check-in guidance system as claimed in any preceding claim, wherein the passenger information input means is adapted to receive and validate money from passengers, and to dispense a voucher only if a required fee is paid.

17. A check-in guidance system as claimed in any preceding claim, wherein said environment is provided with separate service points at which excess baggage payments are collected, and the check-in guidance system further comprises second display means for displaying information, under the control of the computing means, to direct each passenger who is waiting to make an excess baggage payment to a specified one of the service points, in an order determined by the computing means.

18. A check-in guidance system as claimed in claim 17, wherein the service points provide other services in addition to collecting excess baggage payments, and the check-in guidance system further comprises a service point voucher dispenser for dispensing vouchers to people who wish to use a service point but do not require to make an excess baggage payment, each voucher bearing one or more identifying numbers and/or letters which can be displayed by the second display means to guide people to the service points.

19. A check-in guidance system as claimed in any preceding claim, which further comprises service information input means to allow people to specify the service they require, or the nature of their enquiry.

20. A touch sensitive screen for allowing a user to input information into a computing means, the touch sensitive screen being divided into a number of regions, and each region displaying a respective letter of the alphabet so that actuation of any one of said regions by the user causes the letter associated with that region to be displayed at another location on the touch sensitive screen.

21. A touch sensitive screen as claimed in claim 20, which serves as a multilingual keyboard, wherein, after the user has specified the language required, the number of regions on the touch sensitive screen change if the required alphabet has a different number of letters.

22. A queue management system comprising:
a service device for providing people with information, the service device comprising at least a screen for displaying information to users of the service device;
an authorisation device for determining whether people who wish to use the service device are authorised to use the service device;
a waiting area in which people wait after identifying themselves at the first identification device;
display means for displaying information to people waiting in the waiting area; and
computing means for controlling, in response to information received from at least the authorisation device and the service device, the information displayed on the display means so as to direct only those people who are authorised to use the service device sequentially from the waiting area to the service device, in an order determined by the computing means, so that the service device is used by people from the waiting area one after the other.

23. A queue management system as claimed in claim 22, wherein the authorisation device comprises a first identification device for identifying people who wish to use the service device in order to determine whether they are authorised to use the service device.

24. A queue management system as claimed in claim 22 or 23, wherein the authorisation device comprises a payment device for accepting a payment from people wishing to use the service device, and said determination of whether said people are authorised to use the service device depends on whether or not a required payment is made.

25. A queue management system as claimed in any one of claims 22 to 24, which further comprises a second identification device at the location of the service device for identifying people who wish to use the service device, and allowing use of the service device by only those people who have been directed to the service device by the display means.

26. A queue management system as claimed in any one of claims 22 to 25, which further includes a staffed service point operated by a member of staff, wherein the display means displays information to direct people from the waiting area to the service point, in accordance with instructions sent to the display means by the computing means.

27. A queue management system as claimed in claim 26, wherein the computing means decides, on the basis of the identity of each person as determined by the first identification device, where each person should be directed by the display means.

28. A queue management system as claimed in any one of claims 22 to 27, wherein there is more than one service device, and each service device is provided with a respective second identification device.

29. A queue management system as claimed in any one of claims 22 to 28, wherein the authorisation device is provided with input means for allowing the user to specify which of a range of services is required, and the computing means decides where to direct the person on the basis of the choice that person has made at the input means.

30. A queue management system as claimed in any one of claims 22 to 29, which further comprises a ticket dispenser for dispensing tickets to people who are determined by the authorisation device to be authorised people, the tickets bearing one or more identifying numbers or letters, and the display means being adapted to display said identifying numbers or letters in order to direct such authorised people to a service device or service point.

31. A queue management system as claimed in claim 30, when dependent directly or indirectly on claim 25, wherein the ticket dispenser dispenses tickets which are provided with bar codes, and the or each second identification device is provided with a bar code reading device for reading the bar codes on the tickets when the tickets are presented to the second identification device, in order to allow use of the or each service device by only those people who have been directed to the service device by the display means.

32. An automatic visa issuing device, comprising applicant information input means at which an applicant for a visa inputs information relating to the applicant's request for the visa; computing means for storing and processing the information input by the applicant; and visa issuing means for issuing the visa to the applicant if the computing means determines that the applicant is entitled to the visa.

33. An automatic visa issuing device as claimed in claim 32, wherein the visa issuing means comprises an automatic stamping device for stamping the applicant's passport with a stamp representing the visa.

34. An automatic visa issuing device as claimed in claim 32 or 33, wherein the visa issuing means comprises a sticker dispensing device for dispensing a visa sticker to the applicant, which can be stuck in the applicant's passport.

35. An automatic visa issuing device as claimed in any one of claims 32 to 34, wherein the applicant information input means comprises a display screen for displaying general information to the applicant, prompting the applicant for required information, and/or displaying information input by the applicant.

36. An automatic visa issuing device as claimed claim 35, which further comprises a camera, and the display screen is adapted to display an image of the applicant produced by the camera.

37. An automatic visa issuing device as claimed in claim 35 or 36, wherein the screen is a touch sensitive screen of the type claimed in claim 20 or 21.

38. An automatic visa issuing device as claimed in any one of claims 32 to 37, wherein the automatic visa issuing device further comprises payment means for accepting a payment from the applicant before issuing a visa, the issuance of the visa being dependent on the payment made.

39. An automatic visa issuing device as claimed in any one of claims 32 to 38, which further comprises a passport reading device for reading information from the applicant's passport before issuing a visa, the issuance of the visa being dependent on the information read.

40. An automatic visa issuing device as claimed in any one of claims 32 to 39, which further comprises image recording means for recording an image of the applicant, and providing the computing means with a digitised image of the applicant, wherein the computer means compares the digitised image with a digitised image of the owner of the passport presented to the passport reading device, and determines whether the applicant is the true owner of the passport.

41. A queue management system comprising:
a service point for providing people with information;
an arrival device which people who wish to use the service point are required to operate on arrival at the system;
a multilingual instruction display device, comprising at least a screen and being located at or near the arrival device, for displaying information on how to use the system in a plurality of languages;
display means for displaying information to people waiting in the waiting area; and
computing means for controlling, in response to information received from at least the arrival device and the service point, the information displayed on the display means so as to direct people who have operated the arrival device sequentially to the service point, in an order determined by the computing means, so that the service point is used by people one after the other.

42. A queue management system as claimed in claim 41, which further comprises a waiting area in which people wait after operating the arrival device, and wherein the display means directs people sequentially from the waiting area to the service point.

43. A queue management system as claimed in claim 41 or 42, wherein the arrival device comprises an authorisation device for determining whether people who wish to use the service point are authorised to use the service point.

44. A queue management system as claimed in any one of claims 41 to 43, wherein, the multilingual instruction display device comprises a touch sensitive screen, or a screen with buttons arranged alongside it, to enable users to make choices or enter information in response to information displayed by the screen.

45. A queue management system as claimed in any one of claims 41 to 44, wherein the authorisation device comprises a first identification device for identifying people who wish to use the service point in order to determine whether they are authorised to use the service device.

46. A queue management system as claimed in any one of claims 41 to 45, wherein the authorisation device comprises a payment device for accepting a payment from people wishing to use the service point, and said determination of whether said people are authorised to use the service point depends on whether or not a required payment is made.

47. A queue management system as claimed in any one of claims 41 to 46, which further comprises a second identification device at the location of the service point for identifying people who wish to use the service point, and allowing use of the service point by only those people who have been directed to the service point by the display means.

48. A queue management system as claimed in any one of claims 41 to 47, wherein the service point is a staffed service point operated by a member of staff.

49. A queue management system as claimed in any one of claims 41 to 47, wherein the service point is a service device comprising at least a screen for displaying information to users of the service device.

50. A queue management system as claimed in claim 49, wherein the service device is connected to, and controlled by, the computing means.

51. A queue management system as claimed in any one of claims 41 to 47, which comprises both a staffed service point and a service device.

52. A queue management system as claimed in claim 51, wherein the computing means decides, on the basis of the identity of each person as determined by the first identification device, where each person should be directed by the display means.

53. A queue management system as claimed in any one of claims 41 to 52, in which there is more than one service device, and more than one staffed service point, and in which the computer means decides, on the basis of the identity of each person as determined by the first identification device, to which service device or staffed service point each person should be directed by the display means.

54. A queue management system as claimed in claim 53, wherein the authorisation device is provided with input means for allowing the user to specify which of a range of services is required, and the computing means decides where to direct the person on the basis of the choice that person has made at the input means.

55. A queue management system as claimed in claim 54, wherein the input means is provided by the multilingual instruction display device.

56. A queue management system as claimed in any one of claims 41 to 55, wherein the arrival device is provided with a ticket dispenser for dispensing tickets to people operating the arrival device, the tickets bearing one or more identifying numbers or letters, and the display means is adapted to display said identifying numbers and/or letters in order to direct people using the queue management system.

57. A queue management system as claimed in claim 56, wherein the ticket dispenser is adapted to dispense tickets only people who are determined by the authorisation device to be authorised people.

58. A queue management system as claimed in claim 56 or 57, wherein the ticket dispenser dispenses tickets which are provided with bar codes, and the second identification device is provided with a bar code reading device for reading the bar codes on the tickets when the tickets are presented to the second identification device, in order to allow use of the service point by only those people who have been directed to the service point by the display means.

59. A paging device for use in a queue management system having a number of service points for providing people with a service, each service point being operated by a staff member, the paging device comprising:
a paging unit, the operation of which by a staff member causes the next user of the system to be paged to that staff member;
at least one cable connecting the paging unit to a computer controlling the queue management system; and
guide means for guiding at least a portion of said cable from a ceiling above the paging unit to the paging unit, the guide means being provided with ceiling attachment means for attaching an upper portion thereof to said ceiling.

60. A paging device as claimed in claim 59, which further comprises a display for displaying information to the staff member operating the paging unit.

61. A paging device as claimed in claim 59 or 60, where at least a part of the paging unit is supported at the lower end of the guide means.

62. A paging device as claimed in claim 61, wherein the paging unit, or part thereof, supported at the lower end of the guide means is rotatably mounted to the guide means to allow its orientation to be adjusted to suite the staff member operating the paging unit.

63. A paging device as claimed in any one of claims 59 to 62, wherein the guide means is of adjustable length to allow the paging unit, or part thereof, at the lower end of the guide means to be adjusted in height.

64. A paging device as claimed in any one of claims 59 to 63, which further comprises a number identifier supported by the guide means for identifying the number of the staffed service point at which the paging device is located.

65. A method of assessing the ability of a person in a particular field, comprising displaying a plurality of questions on a screen controlled by computing means, recording the responses of the person to said questions, and using the computing means to carry out an analysis of said responses.

66. A method as claimed in claim 65, wherein the questions are displayed serially and the method further includes measuring the time taken by the person to answer each question.

67. A method as claimed in claim 66, which further includes the step of automatically moving on to the next question if the person has not responded to a question within a predetermined time interval.

68. A method as claimed in claim 67, wherein different predetermined time intervals are used for different questions.

69. A method as claimed in claim any one of claims 65 to 68, wherein the questions are displayed more than one at a time, and the computing means includes, as a factor in said analysis, the order in which the person chooses to answer the questions.

70. A method as claimed in any one of claims 65 to 69, which further includes the step of stopping the test if an answer is given to a question which is inconsistent with an answer already given to a previous question.

71. An assessment device adapted to carry out the method of any one of claims 65 to 70, comprising computing means, a screen for displaying the questions, and input means for enabling the person to input responses to the questions.

72. An assessment device as claimed in claim 71, wherein the screen and input means are combined in the form of a touch sensitive screen.

73. A client management system comprising one or more service points for providing clients with a service, and an assessment device as claimed in claim 71 or 72, which people wishing to use a service point are required to operate before proceeding to the service point, wherein the client management system further comprises communication means for communicating at least some of the results of said analysis to the service point.

74. A client management system comprising a plurality of service points for providing clients with a service, and an assessment device as claimed in claim 71 or 72, which people wishing to use a service point are required to operate before proceeding to the service point, wherein clients, after having operated the assessment device are required to proceed to one of the service points, in dependence on the results of said analysis.

75. A client management system comprising an automated service device for providing clients with a service, the service device being adapted to also operate as an assessment device s claimed in claim 71 or 72, and a queuing system for directing people wishing to use the service device to the service device one after the other.

76. A client management system as claimed in claim 75, wherein the service device is adapted to carry out literacy and/or psychometric testing using a method as claimed in any one of claims 65 to 70.
